(19) United States
(12) Patent Application Publication
(10) Pub. No.: US 2015/0169835 A1
(43) Pub. Date: Jun. 18, 2015

(54) FAINT AND FALL ASSESSMENT

(71) Applicants: Mohamed Hussein Hamdan, Salt Lake City, UT (US); Michelino Brignole, Borzonasca (IT); Mark Supiano, Salt Lake City, UT (US); Steven Paul Callahan, Centerville, UT (US); John M. Schreiner, Salt Lake City, UT (US); Franco Greco, Chiavari (IT); Andrea Carlo Ponte, Sestri Levante (IT)

(72) Inventors: Mohamed Hussein Hamdan, Salt Lake City, UT (US); Michelino Brignole, Borzonasca (IT); Mark Supiano, Salt Lake City, UT (US); Steven Paul Callahan, Centerville, UT (US); John M. Schreiner, Salt Lake City, UT (US); Franco Greco, Chiavari (IT); Andrea Carlo Ponte, Sestri Levante (IT)

(73) Assignee: UNIVERSITY OF UTAH RESEARCH FOUNDATION, Salt Lake City, UT (US)

(21) Appl. No.: 14/407,635

(22) PCT Filed: Dec. 1, 2011
(86) PCT No.: PCT/US11/62863

§ 371 Date: Dec. 12, 2014

Related U.S. Application Data
(60) Provisional application No. 61/418,844, filed on Dec. 1, 2010.

(51) Int. Cl. G06F 19/00; G06N 5/04

(52) U.S. Cl. CPC G06F 19/345; G06N 5/04

(57) ABSTRACT

A computer-implemented method of assessing a patient is provided. In some embodiments, the method includes displaying a first set of queries concerning a patient and receiving a response to at least one of the queries, the response indicating that the patient has recently experienced at least one of (i) losing consciousness, (ii) falling, and (iii) being uncertain about whether the patient has lost consciousness. Processing of responses to further query sets can be utilized to determine a differential diagnosis and recommendations regarding hospital admission, treatment, follow-up medical tests, and billing codes for the patient's condition that may have led to her faint or fall.

### CROSS-REFERENCE TO RELATED APPLICATIONS

The present application claims priority to U.S. Provisional patent application Ser. No. 61/418,844, filed on Dec. 1, 2010, the contents of which are hereby incorporated by reference in their entirety, including the various attachments filed therewith.

### FIELD

The present invention generally relates to assessing persons who may have fainted, fallen, or both, and, in particular, systems, methods, and algorithms for identifying a faint, a fall, or both, and providing an accurate diagnosis and cost-effective treatment.

### BACKGROUND

Fainting accounts for up to 3% of all emergency department visits and, in patients above the age of 65 years, it is the sixth leading cause of hospitalization. More than one-third of adults over 65 sustain a fall, many of which are caused by fainting. There is considerable overlap between faint and unexplained falls in the elderly person due to amnesia and the absence of witnesses. In the State of Utah, USA, for example, the annual cost of faints and falls is estimated to be approximately $440 million and is more than $40 billion nationally. According to the Centers for Disease Control, falls constitute about two-thirds of the deaths from unintentional injuries, which is the fifth leading cause of death in the elderly. This problem is growing proportionately with the ever-increasing mortality rates of the population.

Apart from physical injuries and the increased morbidity and mortality, unexplained falls represent a common cause of institutionalizing an otherwise independent elderly person. Inappropriate hospital admissions impose an inconvenience on the patient and his or her family, adversely affecting their schedule and decreasing their productivity. Moreover, misdiagnoses and inappropriate tests impose unwarranted costs on patients who must pay their co-share and could also lead to unnecessary added risks and complications.

In other cases, patients with potentially dangerous fainting and/or falling episodes are often inappropriately discharged from a hospital, thereby resulting in unnecessary risks to the patients and added cost to healthcare payers. In the absence of a correct diagnosis, patients are likely to present again to the health care provider and the emergency department with the same problem.

### SUMMARY

According to certain embodiments of the subject technology, a computer-implemented method of assessing a patient is provided. The method comprises displaying a first set of queries concerning a patient and receiving an indicator response to at least one of the first set of queries. The indicator response indicates that the patient has recently experienced at least one of (i) losing consciousness, (ii) falling, and (iii) being uncertain about whether the patient has lost consciousness.

In some embodiments, when the indicator response indicates that the patient has lost consciousness or is uncertain about whether the patient has lost consciousness, the method comprises: (a) displaying a second set of queries concerning whether the loss of consciousness was triggered by at least one of emotional distress, fear, pain, instrumentation, and a blood phobia; (b) receiving at least one response to the second set of queries; (c) displaying a third set of queries concerning whether at least one of nausea, vomiting, abdominal pain, feeling cold, and sweating of the patient preceded the loss of consciousness; (d) receiving at least one response to the third set of queries; (e) displaying a fourth set of queries configured to determine each of (i) the patient's activity during the loss of consciousness, (ii) patient's position during the loss of consciousness, (iii) a completeness of the loss of consciousness, (iv) patient's breathing pattern immediately prior to the loss of consciousness, (v) patient's skin color immediately prior to the loss of consciousness, (vi) whether the patient exhibited, around the time of the loss of consciousness, at least one of muscle movements, automatisms, tongue biting, urinary or fecal incontinence, prolonged confusion, muscles aches, and trauma, and (vii) whether the patient has experienced prior episodes of loss of consciousness; (f) receiving responses to the fourth set of queries; (g) displaying a fifth set of queries configured to determine each of (i) the patient's history of alcohol intoxication, (ii) the patient's history of drug abuse, and (iii) the patient's history of tobacco use; (h) receiving responses to the fifth set of queries; (i) displaying a sixth set of queries configured to determine aspects of findings of the patient's physical examination; (j) receiving responses to the sixth set of queries; (k) displaying a seventh set of queries configured to determine aspects of each of (i) an electrocardiogram of the patient, (ii) an oxygen saturation of blood of the patient, (iii) blood cell features and blood chemistry features of the patient, and (iv) an echocardiogram of the patient; (1) receiving responses to the seventh set of queries; and (m) based on the responses to the first through seventh sets of queries, determining, by a computer, (i) a recommendation of whether the patient should be admitted to the hospital, (ii) a recommendation for at least one of a diagnosis and a differential diagnosis of a condition that can lead to a loss of consciousness in the patient, and (iii) a recommendation of further medical tests to be performed concerning the patient.

In some embodiments, the method further comprises: based on the responses to the first through seventh sets of queries, determining, by a computer, a recommended category for billing a third party for at least one of a diagnosis, treatment, and hospital stay of the patient. In some embodiments, the method further comprises: based on the responses to the first through seventh sets of queries, determining, by a computer, a recommended category for billing a third party for the patient encounter.

In some embodiments, the method further comprises: based on the responses to the first through seventh sets of queries, determining, by a computer, a recommended treatment for the patient's condition.

In some embodiments, when the indicator response indicates that the patient has fallen, the method further comprises: (a) displaying an eighth set of queries concerning circumstances prior to the patient's fall; (b) receiving at least one response to the eighth set of queries; (c) displaying a ninth set of queries configured to determine each of (i) the patient's history of alcohol intoxication, (ii) the patient's history of drug abuse, and (iii) the patient's history of tobacco use; (d) receiving responses to the ninth set of queries; (e) displaying a tenth set of queries configured to determine aspects of findings of the patient's physical examination; (f) receiving responses to the tenth set of queries; (g) displaying an eleventh set of queries configured to determine aspects of each of (i) an electrocardiogram of the patient, (ii) an oxygen saturation of blood of the patient, (iii) blood cell features and blood chemistry features of the patient, and (iv) an echocardiogram of the patient; (h) receiving responses to the eleventh set of queries; and (i) based on the responses to the eighth through eleventh sets of queries, determining, by a computer, (i) a recommendation of whether the patient should be admitted to the hospital, (ii) a recommendation for at least one of a diagnosis and a differential diagnosis of a condition that can lead to a fall of the patient, and (iii) a recommendation of further medical tests to be performed concerning the patient.

In some embodiments, the method further comprises: based on the responses to the eighth through eleventh sets of queries, determining, by a computer, a recommended category for billing a third party for at least one of a diagnosis, treatment, and hospital stay of the patient. In some embodiments, the method further comprises: based on the responses to the eighth through eleventh sets of queries, determining, by a computer, a recommended category for billing a third party for the patient encounter.

In some embodiments, the method further comprises: based on the responses to the eighth through eleventh sets of queries, determining, by a computer, a recommended treatment for the patient's condition that can lead to a fall. In some embodiments, the method further comprises: when the indicator response indicates that the patient has fallen and is uncertain about whether the patient has lost consciousness, performing the same steps as when the indicator response indicates that the patient has lost consciousness. In some embodiments, the method further comprises: when the indicator response indicates that the patient has fallen and is uncertain about whether the patient has lost consciousness, performing steps (a) through (m) of when the indicator response indicates that the patient has lost consciousness.

In some embodiments, the method further comprises outputting the determined recommendation of (i), (ii), and (iii) of when the indicator response indicates that the patient has lost consciousness to an output device. In some embodiments, the output device comprises at least one of a monitor, a paper, a record, and an electronic file.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the subject technology as claimed.

### BRIEF DESCRIPTION OF THE DRAWINGS

The accompanying drawings, which are included to provide further understanding of the subject technology and are incorporated in and constitute a part of this specification, illustrate aspects of the disclosure and together with the description serve to explain the principles of the subject technology.

FIG. 1a illustrates a flowchart for an exemplary faint assessment algorithm, according to one or more embodiments.

FIG. 1b illustrates a flowchart for an exemplary faint follow-up algorithm, according to one or more embodiments.

FIG. 2a illustrates a flowchart for an exemplary fall assessment algorithm, according to one or more embodiments.

FIG. 2b illustrates a flowchart for an exemplary fall follow-up algorithm, according to one or more embodiments.

FIGS. 3a-3s illustrate various graphical user interfaces (GUI) that graphically depict steps or stages of an exemplary faint assessment algorithm, according to one or more embodiments.

FIGS. 4a-4g illustrate various graphical user interfaces (GUI) that graphically depict steps or stages of an exemplary fall assessment algorithm, according to one or more embodiments.

FIG. 5 illustrates a simplified diagram of a system, in accordance with various embodiments of the subject technology.

FIG. 6 is a conceptual block diagram illustrating an example of a system, in accordance with various embodiments of the subject technology.

FIG. 7 is an exemplary cloud-computing diagram.

FIG. 8 is a bar graph indicating various types of tests and consultations used to determine differences between a standardized approach to diagnosing faint and a conventional approach.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

Fainting is a generic term frequently used at the initial presentation of a patient to describe a brief loss of consciousness, sometimes referred to as a dizzy spell, blacking out or passing out. Fainting, however, may encompass all disorders characterized by transient, self-limited, non-traumatic loss of consciousness. When the cause of faint is transient cerebral hypo-perfusion, the term syncope may be used, indicating specific etiologies. The differential diagnosis may depend on the age of the patient and the patient's medical history, physical examination, electrocardiogram, and/or laboratory findings.

In any event, fainting often leads to anxiety, serious injuries, and hospital admissions. A recent epidemiological study, performed in the State of Utah, USA, showed that the yearly incidence of faint was 9.5 patients per 1000 inhabitants, with 1 out of 10 patients requiring hospitalization. The average payment received by a medical institution per faint patient evaluation was $2,517, resulting in an estimated yearly cost equal to $90,901,958.

Similar to fainting, falling is a common problem, particularly in the elderly, and its impact can be devastating and significantly effect morbidity and mortality rates. Up to thirty-five percent of adults greater than 65 years old sustain at least one fall and the incidence increases to 32%-42% in adults older than 75 years of age. Sometimes, a fall is actually a fainting spell in disguise because patients do not remember losing consciousness and often have no witnesses to help with the history taking. The causes of falling in the elderly can be multi-factorial and can include: 1) drug interaction; 2) gait, balance, and/or lower limb joint abnormalities; 3) cognitive status abnormalities; 4) visual status abnormalities; 5) environmental hazards; and/or 6) cardiovascular abnormalities.

It has been estimated that the annual direct and indirect cost of fall injuries will reach $54.9 billion dollars by 2020 without adjusting for inflation. In a recent study conducted by the University of Utah, the overall prevalence of falls was 29.8 per 1000 inhabitants, which progressively increases with age and reaches values of 70 per 1000 inhabitants in subjects aged 70-79 years, and 115 per 1000 inhabitants in subjects aged greater than 80 years. The mean payment was $3,200 for fall, and the average cost per hospital admission was $19,194. The estimated total yearly payments per 1 million people in the population for the incidental falls were $128,640,000, respectively. For the overall population of the State of Utah, the total yearly payments made by healthcare payers were estimated to be $351,959,040.

The approach to patients with faint or fall remains a challenge, resulting in rising costs and suboptimal yields to diagnosis. Moreover, despite recently published American and European guidelines, the evaluation and treatment of patients with faint or fall is often haphazard and un-stratified. The result is inappropriate use of diagnostic tests and a high rate of misdiagnosis. In non-standardized clinical practice settings, the rate of unexplained faint is about 42%-54%, highlighting the importance of adopting standardized diagnostic protocols and algorithms in the medical practitioner's approach to patients with faint. Similarly, several studies have identified multiple risk factors for fall patients, highlighting the multifaceted nature of this problem.

In a study assessing faint evaluation at the University of Utah Hospital and its nine affiliated primary care and family practice clinics, a final diagnosis was made in only 45% of cases, and less than half of all patients had a confirmed diagnosis. This rate was similar to the 42%-54% rates reported in other medical centers. It was also found that there was underutilization of low-cost but effective tests, such as orthostatic testing (p=0.001), carotid sinus massage (p=0.001), and implantable loop recorders (p=0.07), and overutilization of more costly tests like imaging studies (p=0.001 for both echocardiogram and CT/MRI scan) and neurologic consultation (p=0.001).

Since ascertaining the diagnosis for a fainting event or a fall is generally a pre-requisite to preventing future recurrences, the clinical implications of the above findings are very significant. These results highlight not only the healthcare cost implications but also indicate a need in the field to address this problem.

According to various embodiments of the subject technology, a new guideline-based algorithm is provided in order to help healthcare practitioners reduce inappropriate faint/fall discharges and admissions, thus improving patient care while lowering overall healthcare costs. In some embodiments, valuable tools are provided that can help a healthcare payer and/or provider decide whether the short-term risk is high and an admission is warranted when patients are presented to the emergency department with either a faint or a fall. In an outpatient setting, the healthcare provider and payer may be provided with an informational reference so as to be able to assess whether the tests ordered in the management of patients with faint/fall were cost-effective and in adherence with the most recent American and European cardiac guidelines. By providing readily available information in algorithmic format, healthcare payers and providers may accurately identify appropriate patients for admission, thus meeting the challenge of providing superior patient care at a lower cost.

The exemplary algorithms described and disclosed herein, according to embodiments of the subject technology, may be designed to help identify all the possible causes of fainting and falling, bringing together a multidisciplinary approach to this common problem. The algorithms can provide the health care provider and payer with the educational and decision framework needed to ensure a comprehensive approach to patients presenting with either a fainting spell or a fall event. As a result, the yield to diagnosis may be improved and future recurrences may be prevented, thereby improving patient care and reducing costs.

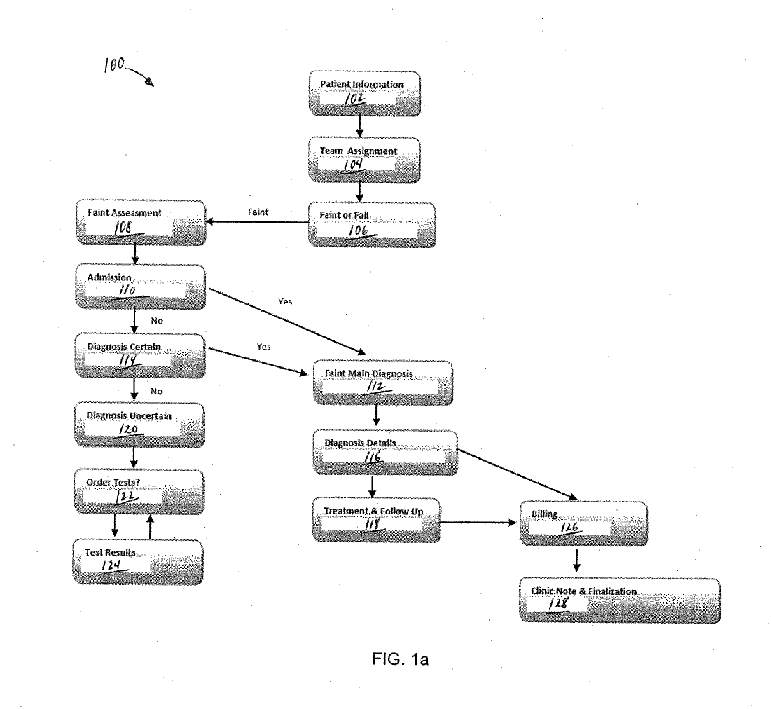

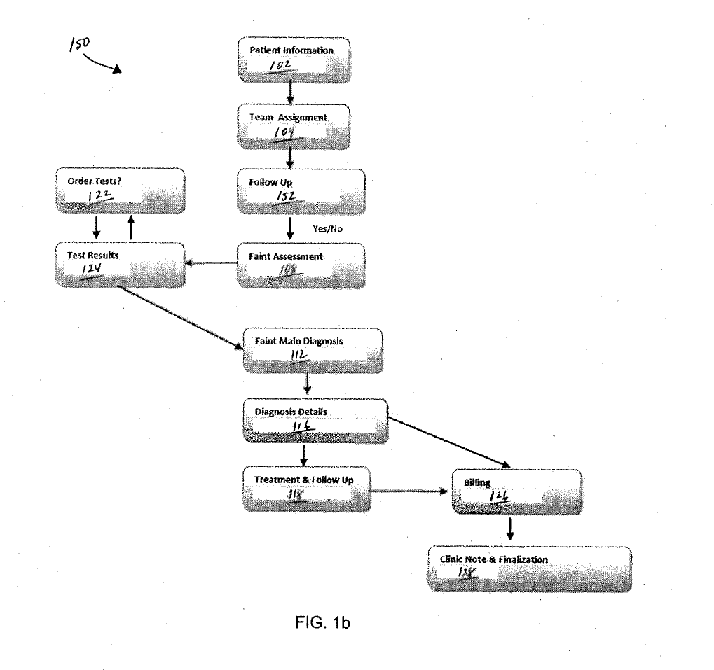

Referring now to FIG. 1a, illustrated is a decision flowchart depicting an exemplary faint assessment algorithm 100, according to one or more embodiments. In some embodiments, the faint assessment algorithm 100 may be a web-based interactive algorithm, which integrates guideline recommendations for risk assessment and admission in a structured diagnostic pathway. Compared to a conventional approach to assessing episodes of faint, utilization of this standardized approach in outpatient care may serve to increase the yield of accurate diagnosis. As will be described in more detail below, the algorithm 100 may be implemented using a computer-based software program and a series of graphical user interfaces allowing a user to input and receive information.

The algorithm 100 provides several steps or stages configured to assess, diagnose, and treat a patient who may have undergone a faint event or episode. In some embodiments, once the patient is presented to a healthcare provider, such as a doctor or a hospital, general patient information and demographics are acquired or otherwise noted, as at 102. General patient information may include patient identification, insurance information, referring physician information, etc., such as is noted during an ordinary intake procedure. Using the acquired patient information, among other factors, the patient may be assigned to a team, such as at 104. Assignment to a team may include assigning the patient to a particular medical personnel, such as a nursing assistant, a medical assistant, a doctor, a physician, or a specialist (e.g., cardiologist, geriatrician, etc.).

At this point, the algorithm 100 may proceed by prompting the assigned medical personnel to preliminarily determine whether the patient has undergone an episode of faint or fall, as at 106. A faint, otherwise known as a transient loss of consciousness, encompasses all disorders characterized by self-limited loss of consciousness, irrespective of mechanism, and includes syncope, epilepsy, and psychogenic disorders. Faint is generally characterized by rapid onset, short duration and spontaneous complete recovery and, in some cases, the patient has an apparent loss of consciousness combined with a complete unawareness of the event. A fall, on the other hand, may be classified as a loss of postural control but where the patient is aware of the event.

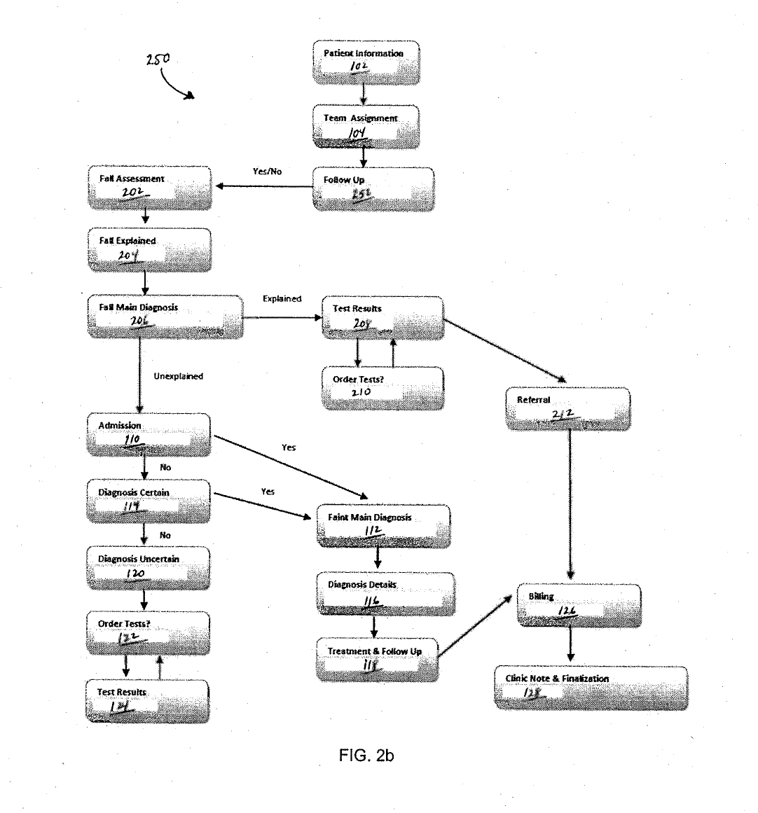

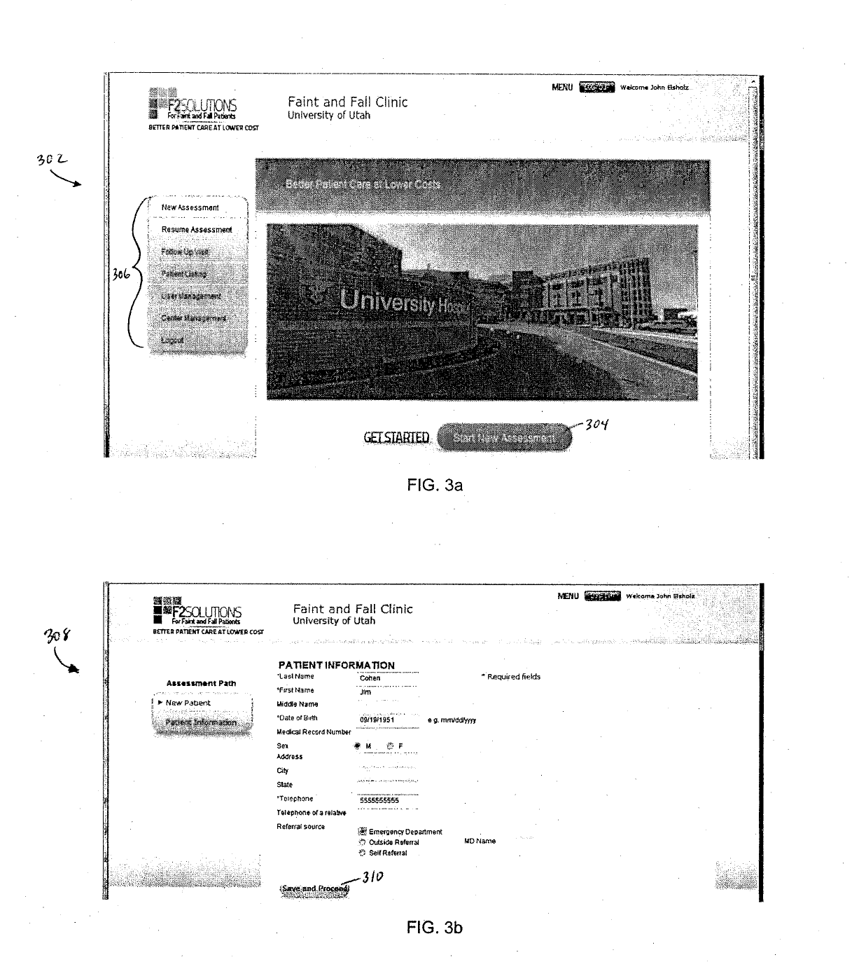

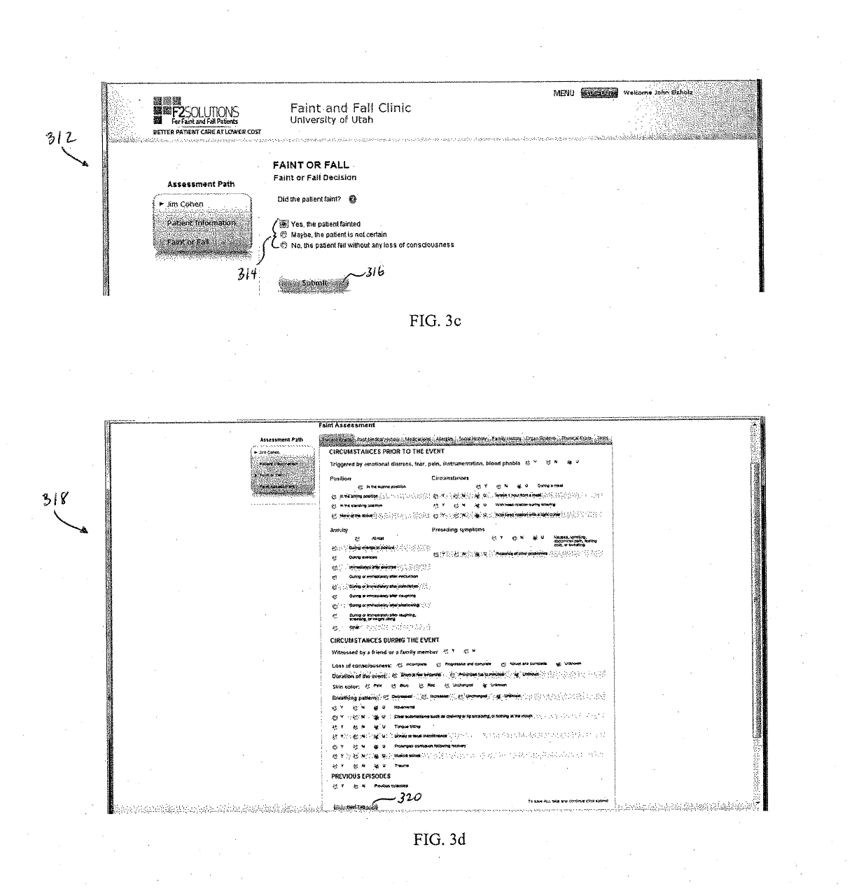

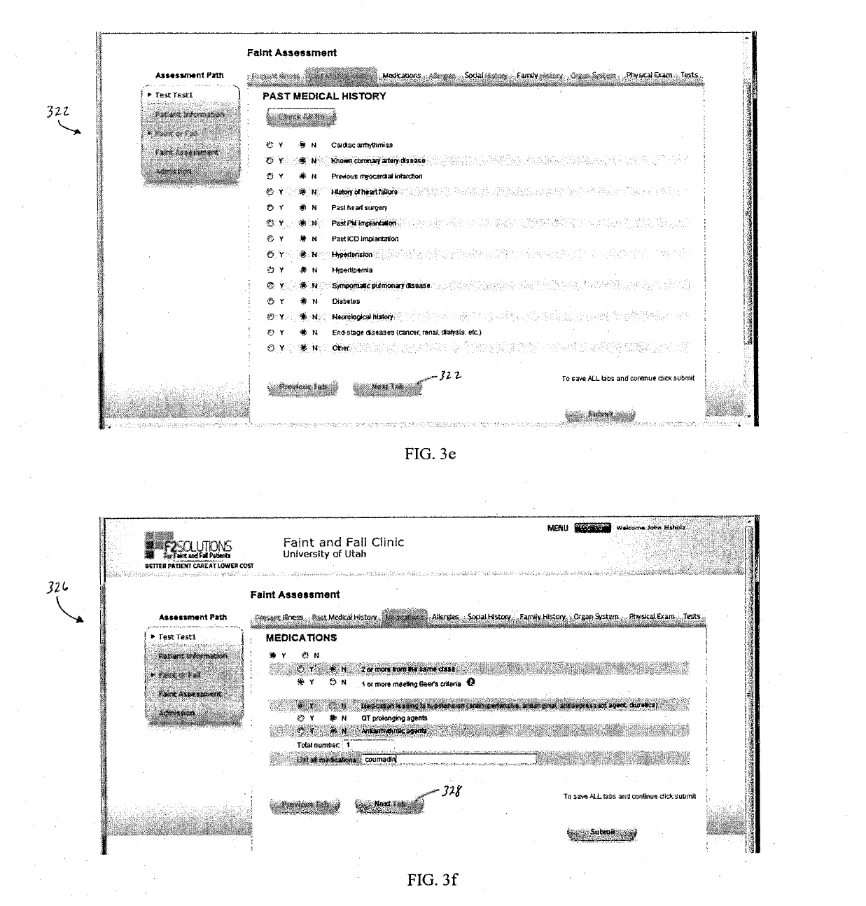

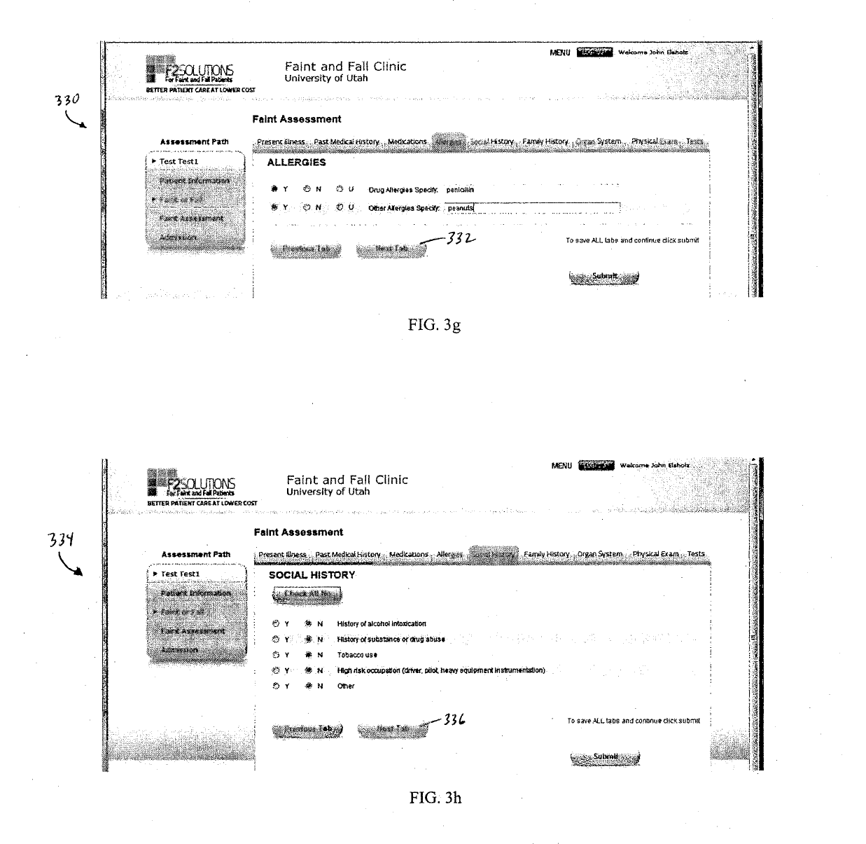

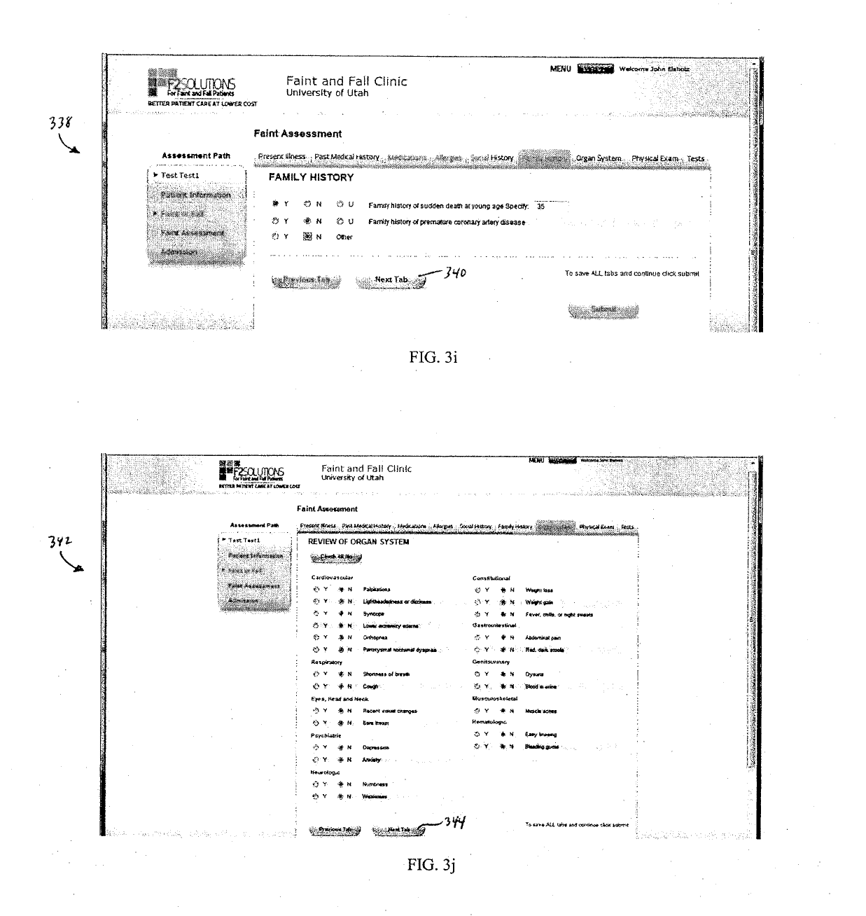

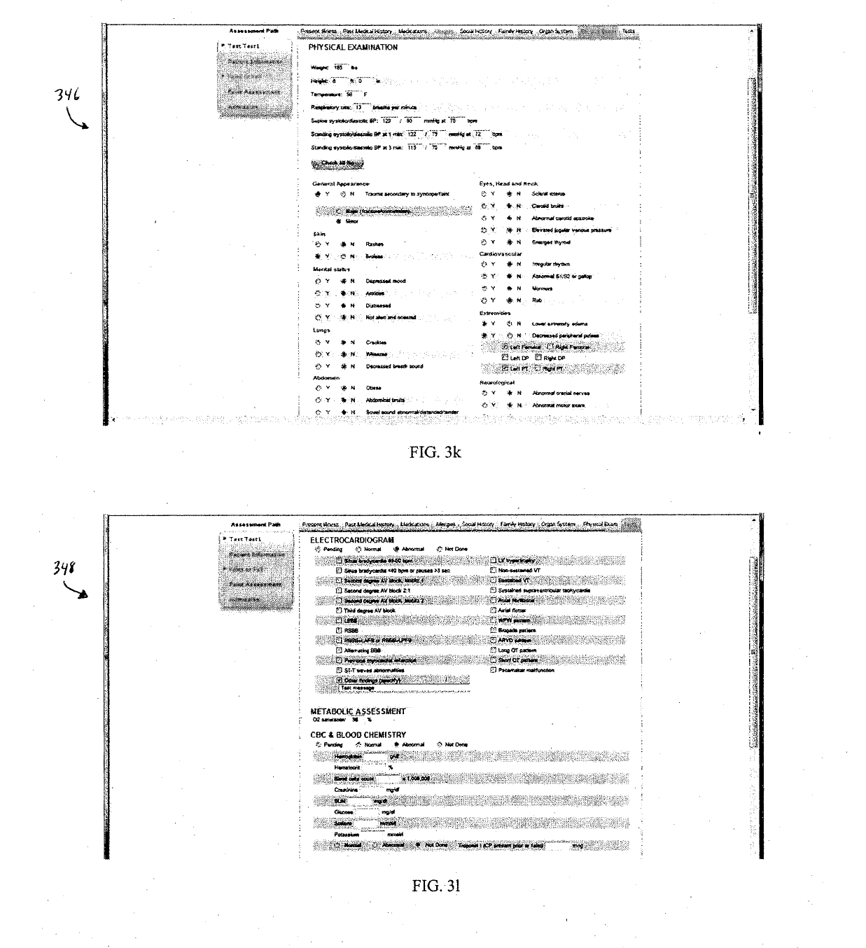

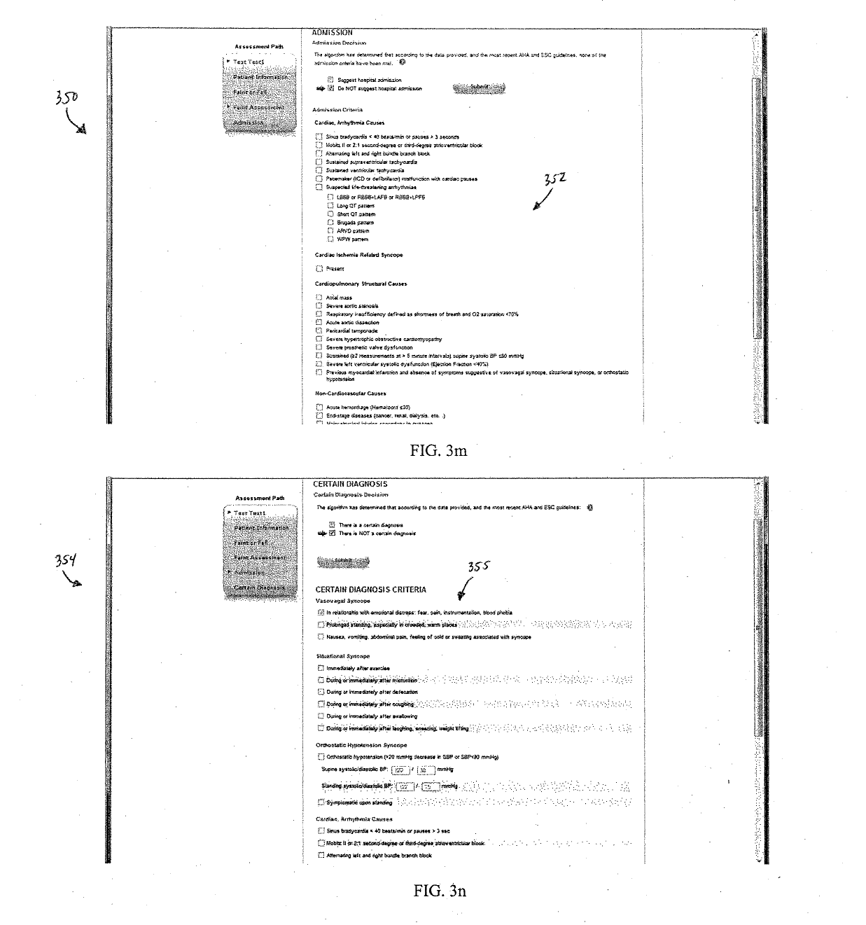

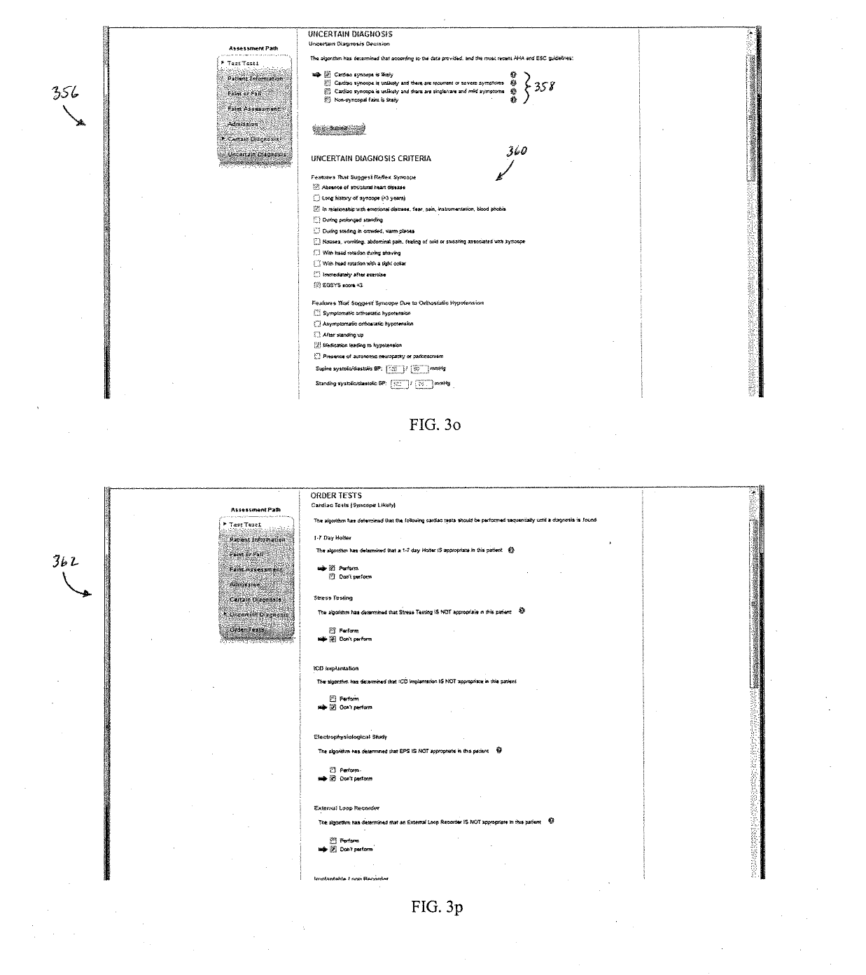

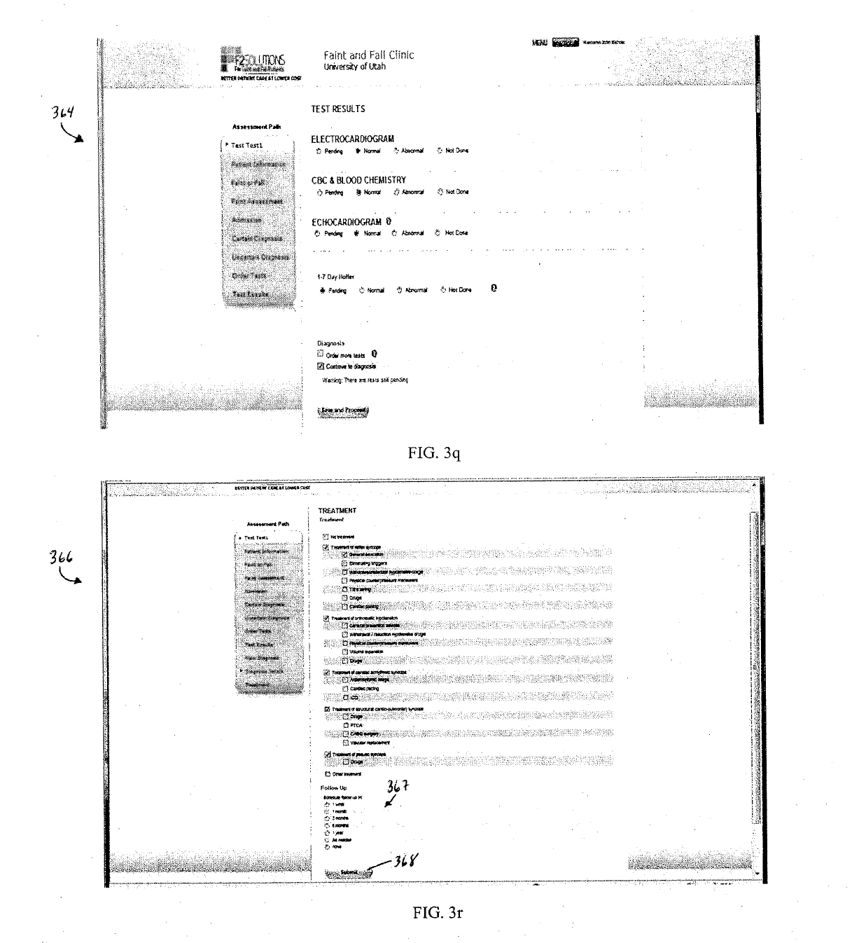

Once a determination that a faint has been suffered by the patient, the algorithm 100 may proceed to assess the fainting episode, as at 108. As will be discussed in greater detail below with reference to FIGS. 3a-3s, the algorithm 100 may provide a series of graphical user interfaces adapted to guide the user through a general assessment of the faint suffered by the patient. For instance, the series of graphical user interfaces may be configured to provide the user with multiple sets of queries configured to evaluate the physical, mental, and medical status and history of the patient. Responses to the several queries are logged in the computer program and the software is configured to process the inputted information to determine what the short-term risk of the patient is. If the short-term risk is high, the algorithm 100 will recommend or suggest that the patient be admitted for treatment, as at 110.

In one or more embodiments, the recommendation to admit the patient or not may be determined or otherwise concluded using the most-recent American and European cardiac guidelines. Accordingly, using up-to-date medical guidelines, the algorithm 100 aids the doctor or physician in deciding whether there is a need for admission or not, based primarily on the data that has been entered and subsequently processed using the software. In one or more embodiments, the physician has the ability to follow the recommendation provided by the algorithm 100 or entirely pursue another course of action.

If it is determined that the patient needs to be admitted, then a faint main diagnosis is reached and the algorithm 100 provides the diagnosis to the user, as at 112. If it is determined not to admit the patient at this time, however, the algorithm 100 proceeds to determine whether there is a certain diagnosis or not, as at 114. Certainty of diagnosis may be obtained, for example, by referencing the published American and European cardiac guidelines which provide certain criteria that need to be met before a certain diagnosis can properly be made. If all the guideline criteria have been met, and therefore a certain diagnosis has been achieved, the software will recognize this and alert the user of this determination by providing a faint main diagnosis, as at 112. With the certain diagnosis, the algorithm 100 may provide the user with the specific details of the diagnosis, as at 116, and the conventional or recommended methods of treatment and follow-up for this type of diagnosis, as at 118. The follow-up 118 stage or step is described in more detail below with reference to FIG. 1b.

If the diagnosis is not certain, however, because the guideline criteria have not been met, then the algorithm 100 reports to the user that an uncertain diagnosis has been obtained, as at 120. In addition to reporting an uncertain diagnosis, the algorithm 100 may be configured to further provide to the user certain diagnoses that are more likely than others, corresponding to the faint assessment information derived in step 108. For example, based on the most recent guidelines, the algorithm 100 may indicate to the user whether the diagnosis is cardiac or non-cardiac.

With an uncertain diagnosis, the algorithm 100 may be configured to prompt the user to undertake a series of recommended tests configured or otherwise tailored to ascertain a certain or proper diagnosis, as at 122. In some embodiments, the algorithm 100 provides the user with a list of recommended tests that are to be undertaken sequentially until the proper diagnosis is ascertained. As the tests are ordered and undertaken, test results are acquired and returned, as at 124. The results are continually processed by the software until the proper diagnosis is ascertained, at which point a faint main diagnosis may be determined, as at 112, and the algorithm 100 proceeds as described above. As can be appreciated, this approach may be a cost-effective approach to diagnosis since the algorithm 100 provides what tests are required and in what order they should be undertaken instead of the physician ordering unnecessary or overly expensive tests.

After the diagnosis details and/or the treatment and follow-up plan is provided to the physician, as at 116 and 118, respectively, the algorithm 100 may initiate a billing sequence, as at 126. In some embodiments, the software running the algorithm 100 may be configured to automatically tally the correct billing with the appropriate billing code depending on how much time was spent with the patient and what tests and/or treatments were undertaken. In some embodiments, the algorithm 100 simply provides the user with the appropriate code to be entered, where the code corresponds to the correct billing information in view of the services provided. Any clinical notes may be appended to the file at this time also, as at 128, and the matter may be considered finalized for the time being. In some embodiments, the algorithm 100 may be configured to automatically generate the clinical note, thereby eliminating the need and time involved for dictation.

Referring to FIG. 1b, illustrated is a faint follow-up algorithm 150 depicting steps or stages that may be undertaken during a follow-up visit for a patient that has previously suffered a faint, according to one or more embodiments. The algorithm 150 may be implemented as an integral part of the faint assessment algorithm 100 discussed above, an in particular as an integral part of the treatment and follow-up step 118 discussed with reference to FIG. 1a. Accordingly, the faint follow-up algorithm 150 may be best understood with reference to FIG. 1a, where like numerals indicate like steps or stages that will not be described again in detail.

Upon the patient being presented at a hospital or clinic for a follow-up visit, the faint follow-up algorithm 150 proceeds by acquiring general patient information and demographics, as at 102, and the patient is once again assigned to a team, as at 104. At this point, the assigned medical personnel may follow-up with the patient and inquire as to whether the patient has suffered additional fainting episodes, as at 152. For example, the patient may be questioned as to whether any additional fainting episodes were similar to the previous episode(s) and how the additional episode was similar or otherwise different than the previous. In one or more embodiments, where a certain diagnosis was previously obtained using the faint assessment algorithm 100, the user may be able to finalize the matter with the newly divulged information. In other embodiments, the user may remain unsure of the proper diagnosis and proceed to assess the newly disclosed fainting episode, as at 108.

To properly diagnose the newly disclosed fainting episode, additional tests may be ordered, as at 122, and the corresponding test results may be evaluated, as at 124. Additional tests and evaluation of test results may be repeated until the faint main diagnosis is obtained, as at 112. With the certain diagnosis obtained, the algorithm 150 may provide the user with the specific details of the diagnosis, as at 116, and the conventional or recommended methods of treatment and follow-up for this type of diagnosis, as at 118. The algorithm 150 may then initiate the billing sequence, as at 126, and any clinical notes may be appended to the file or matter at this time also, as at 128. Accordingly, the matter may be considered finalized for the time being or until another follow-up visit, if needed or recommended, is realized.

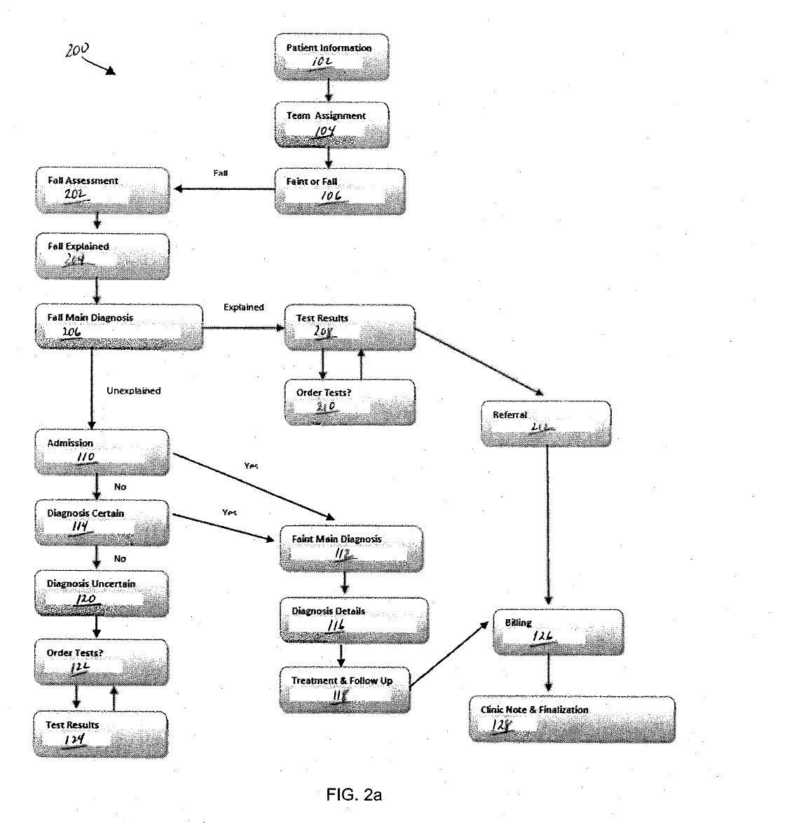

Referring to FIG. 2a, illustrated is a decision flowchart depicting an exemplary fall assessment algorithm 200, according to one or more embodiments. The algorithm 200 provides several steps or stages configured to assess, diagnose, and treat a patient who may have suffered a fall. The fall assessment algorithm 200 may be substantially similar to the faint assessment algorithm 100 described above with reference to FIG. 1a. Accordingly, the fall assessment algorithm 200 may be best understood with reference to FIG. 1a, where like numerals indicate like steps or stages that will not be described again in detail. Similar to the faint assessment algorithm 100, the fall assessment algorithm 200 acquires general patient information and demographics, as at 102, and the patient is then assigned to a team, as at 104.

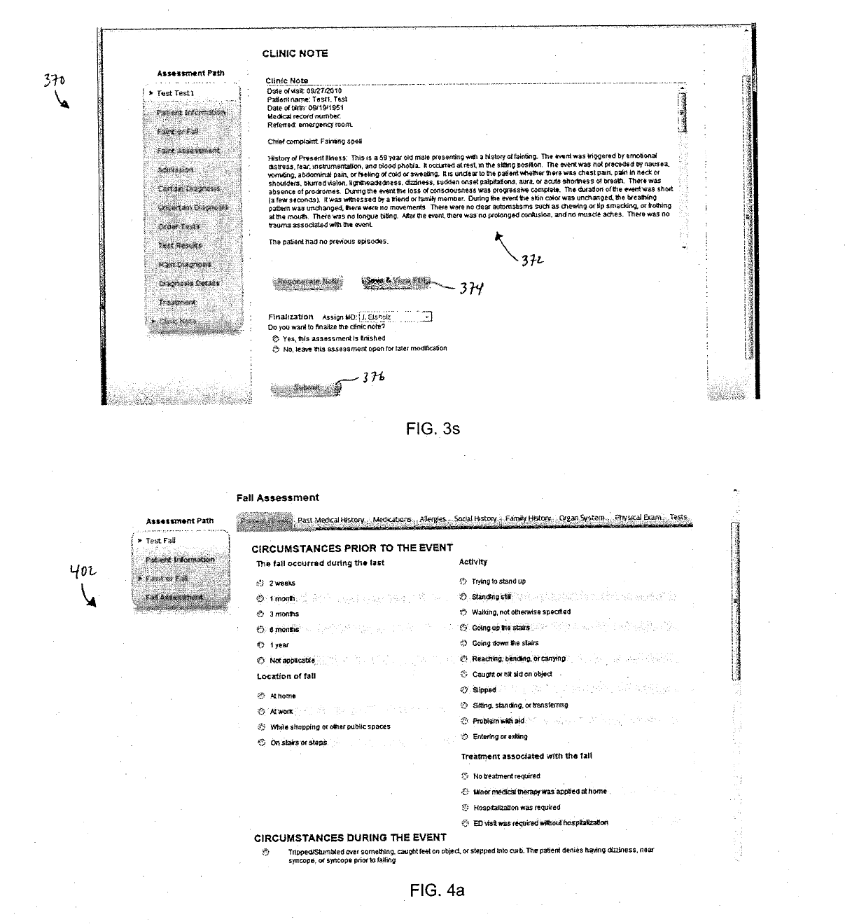

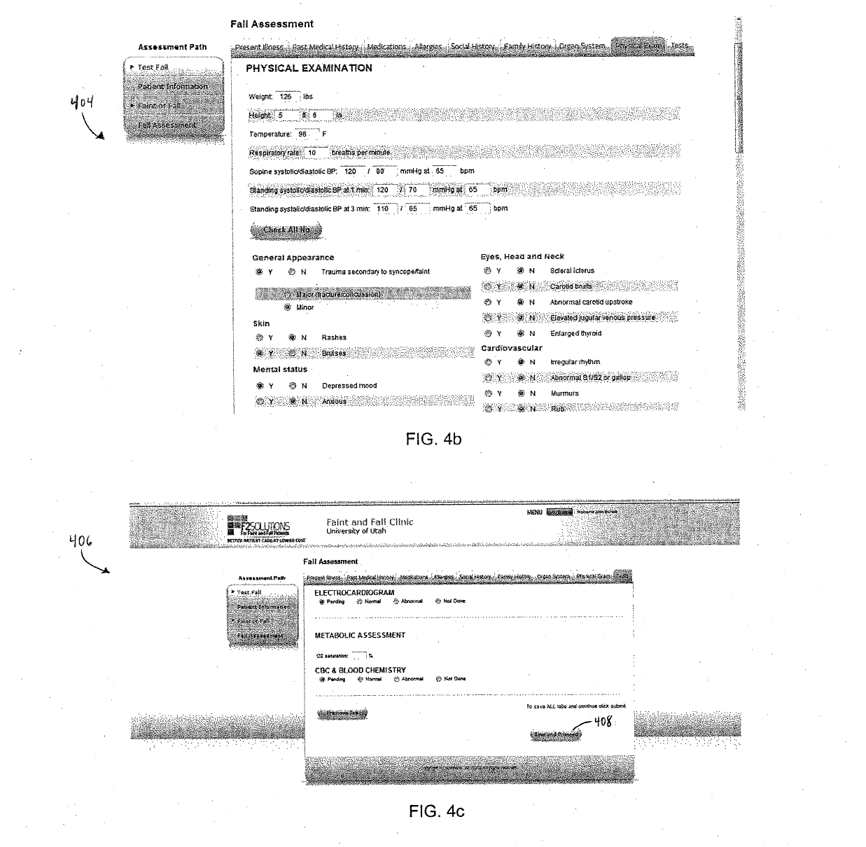

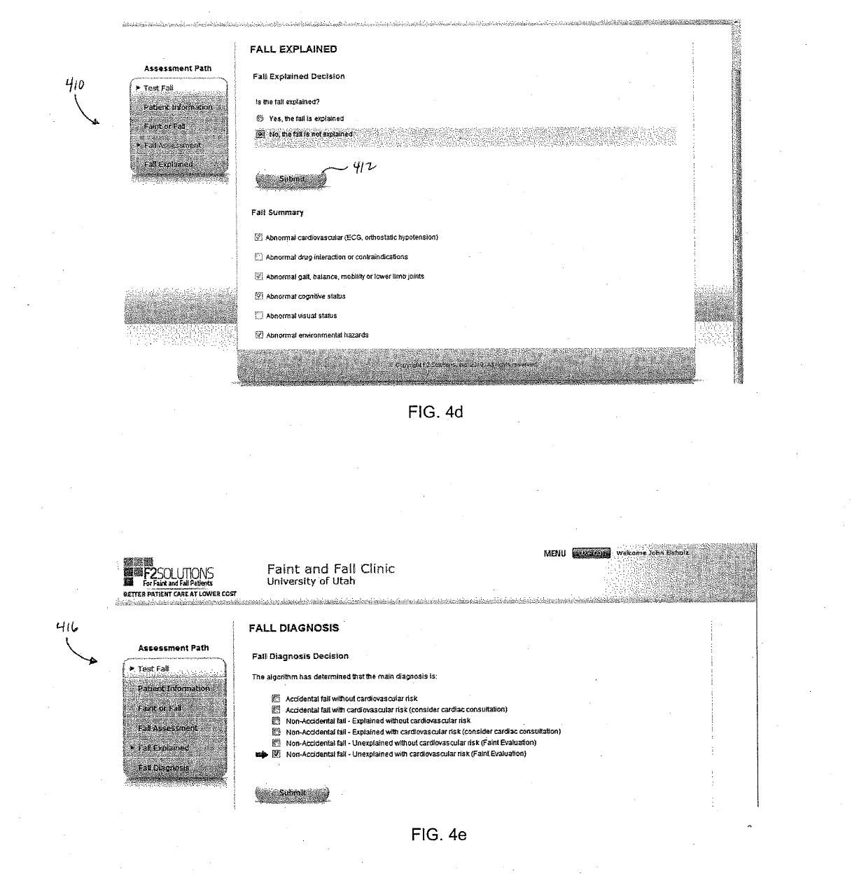

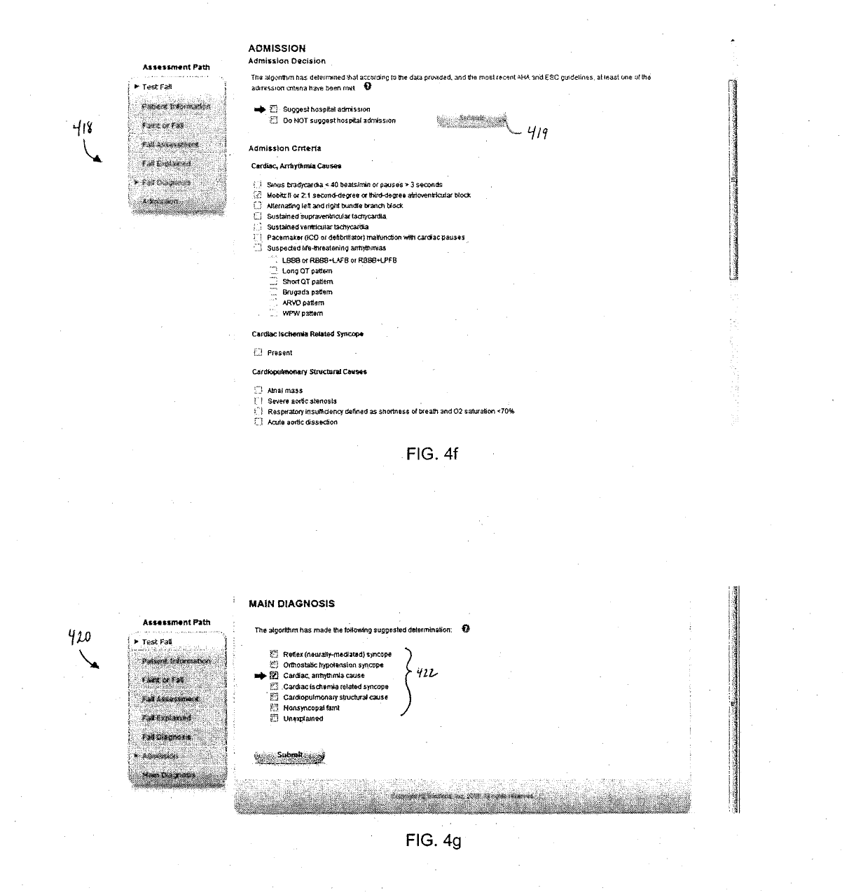

At 106, the assigned medical personnel preliminarily determines whether the patient has undergone an episode of faint or fall. If it is determined that the patient has undergone a fall, the algorithm 200 may proceed to assess the fall episode, as at 202. As will be discussed in greater detail below in FIGS. 4a-4g, and in conjunction with FIGS. 3e-3s, the algorithm 200 may provide a series of graphical user interfaces adapted to assess the fall suffered by the patient. The series of graphical user interfaces may provide the user with multiple sets of queries configured to evaluate the physical, mental, and medical status and history of the patient. Responses to the several queries are logged by the user and the software may be configured to process the information.

After submitting the requested information for the fall assessment in 202, the user may be prompted to declare whether the fall suffered by the patient was explained or unexplained, as a 204. If the user is able to positively identify the reason for the fall, a fall main diagnosis is obtained, as at 206, and the algorithm 200 proceeds to identify potential areas where future medical attention may be required by the patient. For example, if the patient uses a cane but has not engaged a physical therapist, this may trigger an alert by the software of a potential medical condition. Or, if the patient reports various visual disturbances but has not engaged an optometrist to check his/her vision, this may also trigger an alert by the software of a potential medical condition. The algorithm 200 may then provide the user with the opportunity or recommendation to order tests and review the results of the tests, as at 208 and 210, which may be configured to diagnose the alerted potential medical condition(s) of the patient. Depending on the results of the tests, the patient may be referred to a specialist or other physician, as at 212, to remedy the alerted potential medical condition.

If the user is unable to positively identify or explain the reason for the fall, a fall main diagnosis is not obtained. At this point, the algorithm 200 may then be configured to assume that a faint with an unknown diagnosis has been suffered by the patient. This may prove advantageous, especially with the elderly who oftentimes present with a complaint of a fall, but in reality have suffered a faint but there were no third party witnesses of the fall and/or the patient suffers from a type of amnesia. Accordingly, if the fall is unexplained, the algorithm 200 may then be configured to proceed according to the faint assessment algorithm 100 described with reference to FIG. 1a. For instance, the algorithm 200 may first be configured to determine what the short-term risk of the patient is, and if the short-term risk is high, the algorithm 200 will recommend or suggest that the patient be admitted for treatment, as at 110.

If it is determined that the patient needs to be admitted, then a faint main diagnosis is reached and the algorithm 200 provides the diagnosis, as at 112. If it is determined not to admit the patient, the algorithm 200 proceeds to determine whether there is a certain diagnosis or not, as at 114. If a certain diagnosis can be achieved, the software will recognize this and alert the user of this determination by providing a faint main diagnosis, as at 112. With the certain diagnosis, the algorithm 200 may provide the user with the specific details of the diagnosis, as at 116, and the conventional or recommended methods of treatment and follow-up for this type of diagnosis, as a 118.

If the diagnosis is not certain, however, then the algorithm 200 reports to the user that an uncertain diagnosis has been obtained, as at 120. With an uncertain diagnosis, the algorithm 200 may be configured to prompt the user to undertake a series of recommended tests configured to ascertain a certain or proper diagnosis, as at 122. As the tests are ordered and undertaken, test results are acquired and returned, as at 124. The steps of ordering tests and evaluating the results may be repeated until the proper diagnosis is ascertained, at which point a faint main diagnosis may be determined, as at 112, and the algorithm 200 proceeds as described above from 112. Following the treatment and follow-up plan being provided to the physician, as at 118, the algorithm 200 may initiate the billing sequence, as at 126, and any clinical notes may be appended to the file at this time also, as at 128. The matter may be considered finalized for the time being or at least until a follow-up visit (if needed or recommended) is realized.

Referring to FIG. 2b, illustrated is a fall follow-up algorithm 250 depicting steps or stages that may be undertaken during a follow-up visit for a patient that has previously suffered a fall, according to one or more embodiments. The algorithm 250 may be implemented as an integral part of the fall assessment algorithm 200 discussed above with reference to FIG. 2a, an in particular as an integral part of the treatment and follow-up step 118 discussed therein. Accordingly, the fall follow-up algorithm 250 may be best understood with reference to FIG. 2a, where like numerals indicate like steps or stages that will not be described again in detail.

Upon the patient being presented for a follow-up visit with respect to a fall, the fall follow-up algorithm 250 proceeds by acquiring general patient information and demographics, as at 102, and the patient is once again assigned to a team, as at 104. At this point, the assigned medical personnel may follow-up with the patient by inquiring as to whether the patient has suffered any additional falls since the last visit, as at 252. For example, the patient may be questioned as to whether any additional fall(s) were similar to the previous fall(s) and how the additional fall(s) was similar or otherwise different. In one or more embodiments, where a certain diagnosis was previously obtained using the fall assessment algorithm 200, the user may be able to finalize the matter with the newly divulged information. In other embodiments, the user may remain unsure of the proper diagnosis and proceed to assess the newly disclosed fall episode, as at 202. The remaining steps or stages of the fall follow-up algorithm 250 may be substantially similar to the fall assessment algorithm 200 described above in FIG. 2a, and therefore will not be described again.

Referring now to FIGS. 3a-3s, illustrated are various graphical user interfaces (GUI) that graphically depict steps or stages of an exemplary faint assessment algorithm, such as the faint assessment algorithm 100 described above, according to one or more embodiments. FIG. 3a depicts an exemplary log-in screen 302 that provides users with a secure virtual private network login portal. Users may access the faint assessment algorithm via the log-in screen 302 using various Internet browsers, such as CHROME®, SAFARI®, FIREFOX®, INTERNET EXPLORER®, etc. The log-in screen 302 may provide the user with a “Start New Assessment” option 304 which may be clicked by the user using a mouse or other appropriate peripheral device to enter the system and begin the assessment based on the algorithm. Otherwise the user may be given other options 306 in the log-in screen 302, such as resuming a previously-commenced assessment, providing information or details for a follow-up visit, or logging out of the network.

Once logging into the network or system, the user may be prompted to enter general patient information via a new patient GUI 308, as depicted in FIG. 3b. In some embodiments, the new patient GUI 308 may be a graphical representation of step 102, as discussed and illustrated above with reference to FIGS. 1a and 2a. After populating the new patient GUI 308, the user may either save the information or proceed to the next GUI or screen by clicking the “Save and Proceed” button 310.

In FIG. 3c, the user is presented with a Faint or Fall GUI 312, which provides a series of queries 314 configured to determine whether the patient has experienced a fainting episode or a fall event. In some embodiments, this GUI 312 may be a graphical representation of step 106, as discussed and illustrated above with reference to FIGS. 1a and 2a. To determine whether a faint or a fall has been suffered, the series of queries 314 may inquire as to whether the patient has recently experienced at least one of (i) losing consciousness, (ii) falling, and (iii) being uncertain about whether the patient has lost consciousness. For example, in some embodiments, as illustrated in FIG. 3c, the user may be presented with at least three possible selections, “Yes, the patient fainted,” “Maybe, the patient is not certain,” and “No, the patient fell without any loss of consciousness.” Depending on the selection or the indicator response to the series of queries, the user may be taken to either the faint assessment algorithm 100 or the fall assessment algorithm 200, as generally described above with reference to FIGS. 1a and 2a, respectively. After making a selection from the series of queries 314, the user may proceed by clicking the “Submit” button 316.

When the indicator response indicates that the patient has lost consciousness or it is otherwise determined that the patient has indeed suffered a fainting episode, or when the indicator response indicates that the patient has fallen and is uncertain about whether the patient has lost consciousness, the user is directed through a general assessment of the fainting episode, such as the faint assessment described above with reference to FIG. 1a in step 108. Accordingly, the following FIGS. 3d-3l illustrate various graphical user interfaces configured to assess the fainting episode suffered by the patient and may be graphical representations of step 108 in FIG. 1a.

Referring to FIG. 3d, the user may be presented with a faint circumstances GUI 318 which may request the user to provide information relating to the circumstances surrounding the fainting event. For example, a series or set of queries may inquire as to whether the loss of consciousness was triggered by at least one of emotional distress, fear, pain, instrumentation, and a blood phobia. The user may also be prompted to determine the patient's activity and position during the loss of consciousness. For example, the user may be asked whether he/she was sitting or standing, whether the faint occurred during or before/after a meal, or whether the faint occurred during a change in posture, exercise, coughing, swallowing, laughing, etc. The faint circumstances GUI 318 may further inquire as to whether at least one of nausea, vomiting, abdominal pain, feeling cold, and sweating of the patient preceded the loss of consciousness.

In some embodiments, the series or set of queries provided in the faint circumstances GUI 318 may further inquire as to whether the faint was witnesses by a third party, whether the loss of consciousness was complete or incomplete, the status of the patient's breathing pattern immediately prior to the loss of consciousness, and the patient's skin color immediately prior to the loss of consciousness. Furthermore, the faint circumstances GUI 318 may inquire as to whether the patient exhibited, around the time of the loss of consciousness, at least one of muscle movements, automatisms, tongue biting, urinary or fecal incontinence, prolonged confusion, muscles aches, and/or trauma. The faint circumstances GUI 318 may further inquire as to whether the patient has had any prior episodes of loss of consciousness. After inputting the appropriate responses to the various queries, the faint assessment may proceed by clicking a “Next Tab” button 320.

Referring to FIG. 3e, illustrated is an exemplary medical history GUI 322 presented to the user to obtain information regarding the patient's past medical history. For example, the medical history GUI 322 may include a set or series of queries to determine whether the patient has ever suffered from one or more of the following: cardiac arrhythmias, known coronary artery disease, a previous myocardial infarction, a history of hear failure, any past heart surgery, a past pacemaker implantation, a past implantable cardioverter defibrillator implantation, hypertension, hyperlipemia, symptomatic pulmonary disease, diabetes, neurological history, end-stage diseases (e.g., cancer, renal, dialysis, etc.), and others. After inputting the responses to the various queries, the faint assessment may proceed by clicking a “Next Tab” button 324.

In FIG. 3f, depicted is a medications GUI 326 which may provide a set of queries designed to obtain the patient's current medication usage. For example, the medications GUI 326 may prompt the user to respond as to whether the patient currently consumes two or more medications from the same class, one or more medications meeting Beers criteria, medication leading to hypotension (e.g., antihypertensive, antianginal, antidepressant agent, diuretics), QT prolonging agents, antiarrhythmic agents, and more. After inputting the responses to the various queries, the faint assessment may proceed by clicking a “Next Tab” button 328.

FIG. 3g depicts an allergies GUI 330 that may be configured to identify one or more allergies that the patient may suffer from. After providing allergy information, if any, the faint assessment may proceed by clicking a “Next Tab” button 332. FIG. 3h illustrates a social history GUI 334 that may provide another set of queries configured to determine one or more of the patient's history of alcohol intoxication, the patient's history of drug abuse, the patient's history of tobacco use, whether the patient is engaged in a high-risk occupation, etc. After inputting the appropriate responses to the various queries, the faint assessment may proceed by clicking a “Next Tab” button 336.

Referring to FIG. 3i, illustrated is a family history GUI 338 that may be configured to obtain family medical history from the patient. For example, the family history GUI 338 may present a set of queries to determine whether there is family history of sudden death at a young age or whether there is family history of premature coronary artery disease. As will be appreciated, many other queries may be presented in the family history GUI 338 without departing from the scope of the disclosure. After inputting the appropriate responses to the various queries, the faint assessment may proceed by clicking a “Next Tab” button 340.

Referring to FIG. 3j, illustrated is an organ system GUI 342 that may be configured to obtain information form the patient regarding the current status of patient's various bodily organs which may or may not be connected to the fainting episode. For example, the organ system GUI 342 may inquire as to the patient's cardiovascular (e.g., palpitations, lightheadedness or dizziness, sncope, lower extremity edema, orthopnea, and/or paroxysmal nocturnal dyspnea), respiratory (e.g., shortness of breath, coughing, etc.), neurologic (e.g., numbness, weakness, etc.), gastrointestinal (e.g., abdominal pain, red, dark stools, etc), genitourinary (e.g., dysuria, blood in urine, etc.), musculoskeletal (e.g., muscle aches, etc.), and/or hematologic (e.g., easy bruising, bleeding gums, etc.) systems. In some embodiments, the organ system GUI 342 may further inquire as to the status of the patient's eyes, head, and neck (e.g., recent visual changes, sore throat, etc.), whether the patient is depressed or has anxiety, and/or whether the patient has experienced weight loss or gain, fever, chills, or night sweats. After inputting the appropriate responses to the various queries, the faint assessment may proceed by clicking a “Next Tab” button 344.

Referring to FIG. 3k, illustrated is a physical examination GUI 346 configured to determine aspects of findings of the patient's physical examination and allow the user to input those findings for consideration and computation using the algorithm. For example, the physical examination GUI 346 may inquire as to the patient's weight, height, temperature, respiratory rate, and blood pressure. The physical examination GUI 346 may further request information relating to the patient's general appearance (e.g., whether there is any trauma secondary to syncope), skin condition (e.g., rashes, bruises, etc.), mental status (e.g., depressed mood, anxious, distressed, not alert and oriented, etc.), abdomen (e.g., obesity, abdominal bruits, bowel sound abnormal/distended/tender, etc.), eyes, head and neck (e.g., scleral icterus, carotid bruits, abnormal carotid upstroke, elevated jugular venous pressure, enlarged thyroid, etc.), cardiovascular (irregular rhythm, abnormal S1/S2 or gallop, murmurs, rub, etc.), extremities (e.g., lower extremity edema, decreased peripheral pulses, etc.), and neurological status (e.g., abnormal cranial nerves, abnormal motor exam, abnormal sensory exam, abnormal gain, etc.). As will be appreciated, other embodiments of the physical examination GUI 346 may include additional requests for information, without departing from the scope of the disclosure. After inputting the appropriate responses to the various queries, the faint assessment may proceed by clicking a “Next Tab” button (not shown).

Referring now to FIG. 3l, illustrated is a tests GUI 348 configured to provide a series or set of queries configured to determine aspects of various medical tests undertaken by the patient. For example, the tests GUI 348 may allow the user to input results of an electrocardiogram of the patient, an oxygen saturation of blood of the patient, blood cell features and blood chemistry features of the patient, and an echocardiogram of the patient. Once the various tests results have been populated or otherwise added to the tests GUI 348, the user may submit the faint assessment information by clicking a “Submit” button (not shown).

The software that facilitates the faint assessment algorithm may be configured to process the submitted faint assessment information and determine the short-term risk and possible need for hospital admission. As noted above, the software may be pre-programmed with the previously-published and/or otherwise up-to-date American and/or European cardiac guidelines and criteria in order to properly assess the faint assessment information and provide an appropriate admission determination. FIG. 3m illustrates an admission GUI 350 which provides the user with a recommendation as to whether the patient be admitted to a hospital for treatment or not. In some embodiments, FIG. 3m is a graphical representation of step 110 as described above with reference to FIG. 1a. If the short-term risk is determined to be high, the admission GUI 350 may be configured to recommend or otherwise suggest that the patient be admitted for treatment, and may provide a listing of the criteria used to reach said recommendation. At this point, the health care provider may be given the opportunity to agree or disagree with the recommendation provided by the algorithm.

If a decision is made not to admit the patient, the software may be configured to use the available information to assess whether a certain diagnosis can be made. In some embodiments, this may be accomplished by verifying how much of the information entered meet the diagnostic criteria for a given diagnosis as defined in the most-recent guidelines. This information may be provided to the user via a certain diagnosis GUI 354, as depicted in FIG. 3n, which may alert the user as to whether a certain diagnosis has or has not been ascertained. In some embodiments, FIG. 3n is a graphical representation of step 114 as described above with reference to FIG. 1a. The certain diagnosis GUI 354 may further reference or otherwise provide to the user various criteria 355 that may be used to reach the conclusion it has presented. If all the applicable criteria 355 have been met, and therefore a certain diagnosis has been achieved, the software will recognize this and may be configured to alert the user of this determination in the certain diagnosis GUI 354.

Referring to FIG. 3o, if the diagnosis is not certain, the user may then be presented with an uncertain diagnosis GUI 356. In some embodiments, FIG. 3o is a graphical representation of step 120 as described above with reference to FIG. 1a. The uncertain diagnosis GUI 356 may be configured to provide the user with one or more potential diagnoses 358, such as a differential diagnosis of a condition that may have led to the loss of consciousness in the patient. The uncertain diagnosis GUI 356 may further provide the user with the criteria 360 that may be relied upon to reach these potential diagnoses 358.

Referring to FIG. 3p, depicted is an order tests GUI 362 which may be provided to the user to identify one or more recommended tests and their recommended order of undertaking in order to obtain a certain diagnosis. In some embodiments, FIG. 3p is a graphical representation of step 122 as described above with reference to FIG. 1a. The recommended tests may be automatically populated by the algorithm, based on the guidelines, and tailored to ascertain a proper certain diagnosis. In some embodiments, the physician may be given the ability to select or refuse the recommended tests and submit the ordered tests into the system for processing. FIG. 3q depicts an exemplary test results GUI 364 that may be provided to the user, and may be a graphical representation of step 124 as described above with reference to FIG. 1a. When ordered tests are returned, the user is able to populate the test results GUI 364 with the corresponding results which are automatically added into the algorithm for further processing. In some embodiments, the user repeats the process of ordering tests and inputting test results, as shown in FIGS. 3p and 3q, respectively, until a certain diagnosis is eventually obtained.

Referring to FIG. 3r, illustrated is a treatment GUI 366 that may be provided to the user once a certain diagnosis is obtained. In some embodiments, FIG. 3r is a graphical representation of step 118 as described above with reference to FIG. 1a. The treatment GUI 366 may provide the user with a recommended treatment plan corresponding to the faint main diagnosis obtained. The treatment GUI 366 may also provide the user with a follow-up plan 367 where the user is able to choose the time-frame for an appropriate follow-up visit. Once the desired treatment and follow-up plans are selected by the user, the user may submit the information by clicking a “Submit” button 368.

Upon submitting the treatment and follow-up plan, the software may be configured to provide the user with a clinic note GUI 370, as depicted in FIG. 3s. In some embodiments, FIG. 3s is a graphical representation of step 128 as described above with reference to FIG. 1a. The clinic note GUI 370 may display and automatically generate a clinic note 372 which provides a summary of the patient visit, the determinations made, and the recommended course(s) of action. As can be appreciated, this may prove advantageous since it eliminates the need and time involved for dictation. Moreover, the clinic note GUI 370 may allow the user to edit the clinic note 372 using a keyboard or other suitable peripheral device. The clinic note 372 may also be saved, viewed, and/or printed by clicking on a button 374. Lastly, the clinic note GUI 370 may give the user the option to finalize the clinic note, or leave the assessment open for later modifications. Submission of the finalized assessment may be done by clicking on the “Submit” button 376.

Referring now to FIGS. 4a-4g, illustrated are various graphical user interfaces (GUI) that depict steps or stages of an exemplary fall assessment algorithm, such as the fall assessment algorithm 200 described above, according to one or more embodiments. Various GUIs that graphically depict the fall assessment algorithm may be substantially similar to many of the GUIs discussed and depicted above with reference to FIGS. 3a-3s and the corresponding exemplary faint assessment algorithm. Accordingly, the exemplary fall assessment algorithm may be best understood with further reference to FIGS. 3a-3s, where similar GUIs will not be depicted or otherwise described again in detail. For example, the log-in screen 302 shown in FIG. 3a, the new patient GUI 308 shown in FIG. 3b, and the Faint or Fall GUI 312 shown in FIG. 3c may equally be used in conjunction with the fall assessment algorithm to provide users with a secure virtual private network login portal, a location to enter general patient information, and a series of queries configured to determine whether the patient has experienced a faint or a fall episode, respectively.

If the indicator response in the Faint or Fall GUI 312 indicates that the patient has fallen without any loss of consciousness, the user may be directed through a general assessment of the patient's fall, such as an assessment similar to the fall assessment described above with reference to FIG. 2a in step 202. In particular, FIGS. 4a-4c described below, in conjunction with FIGS. 3e-3j described above, may cooperatively illustrate various graphical user interfaces configured to assess the fall suffered by the patient and may be graphical representations of step 202 from FIG. 2a.

Referring to FIG. 4a, illustrated is a fall circumstances GUI 402 which may request the user to provide information relating to the circumstances surrounding the fall. For example, the fall circumstances GUI 402 may provide a series or set of queries that may inquire as to the patient's circumstances prior to the fall event, such as when the fall occurred, the location of the fall (e.g., at home, at work, while shopping or other public locations, on stairs or steps, etc.), and/or the activity the patient was undertaking when the fall occurred (e.g., trying to stand up, standing still, walking, going up or down stairs, reaching, bending, carrying an object, caught or hit walking aid on something, slipped, sitting, transferring, entering or exiting, etc.). The fall circumstances GUI 402 may also inquire as to whether any medical treatment was administered to the patient as a result of the fall and whether the patient suffered any prior episodes of falling.

The fall circumstances GUI 402 may further inquire as to the patient's circumstances during the fall event, such as whether the patient tripped or stumbled over something (e.g., caught his/her feet on something or stepped into a curb, and whether the patient denies having dizziness, near syncope, or syncope prior to the fall event), whether the patient felt lightheaded before falling but denies having near syncope or syncope, whether the patient had vertigo before falling but denies having near syncope or syncope, and/or whether the patient denies having tripped or stumbled or experiencing lightheadedness or vertigo prior to falling. Other circumstances that may be inquired about may include whether there was any trauma associated with the fall, whether the patient uses an assist device, whether the patient has a fear of falling, and whether there was any alcohol use involved. Yet other circumstances that may be inquired about may include the visual status of the patient (e.g., history of visual problems, visual changes, whether there has been a vision exam within the last year, etc.) and any environmental hazards (e.g., poor lighting, loose carpet, lack of bathroom safety equipment, whether there are stairs at the home, whether the bathroom is at the same level as the living room, elevated toilet seat, etc.).

After populating the appropriate information into the fall circumstances GUI 402, the user may continue the assessment of the fall event by clicking a “Next Tab” button (not shown) or the like. The user may then be presented with a series of GUIs configured to evaluate the physical, mental, and medical status and history of the patient. In one or more embodiments, the series of GUIs may include the medical history GUI 322 of FIG. 3e to obtain the patient's past medical history, the medications GUI 326 of FIG. 3f to obtain the patient's current medication usage, the allergies GUI 330 of FIG. 3g to identify one or more allergies that the patient may suffer from, the family history GUI 338 of FIG. 3i to obtain family medical history from the patient, and the organ system GUI 342 of FIG. 3j to obtain information from the patient regarding the current status of patient's various bodily organs which may or may not be connected to the fall event.

Assessment of the fall event may proceed by presenting the user with a physical examination GUI 404, as depicted in FIG. 4b. The physical examination GUI 404 may be configured to determine aspects of findings of the patient's physical examination and allow the user to input those findings for consideration and computation using the fall algorithm. For example, the physical examination GUI 404 may inquire as to the patient's weight, height, temperature, respiratory rate, and blood pressure. The physical examination GUI 404 may also request information relating to the patient's general appearance (e.g., whether there is any trauma secondary to syncope, whether the trauma is considered major or minor), skin condition (e.g., rashes, bruises, etc.), mental status (e.g., depressed mood, anxious, distressed, not alert and oriented, etc.), lungs, (crackles, wheezes, decreased breath sound, etc.), abdomen (e.g., obesity, abdominal bruits, bowel sound abnormal/distended/tender, etc.), eyes, head and neck (e.g., scleral icterus, carotid bruits, abnormal carotid upstroke, elevated jugular venous pressure, enlarged thyroid, etc.), cardiovascular (irregular rhythm, abnormal S1/S2 or gallop, murmurs, rub, etc.), and/or extremities (e.g., lower extremity edema, decreased peripheral pulses, etc.).

The physical examination GUI 404 may further request information regarding the patient's neurological status (e.g., abnormal cranial nerves, abnormal motor exam, abnormal sensory exam, abnormal gain, etc.), the patient's cognitive status (e.g., whether normal daily activities are impaired, number of items immediately recalled test, clock draw test, number of items final recall test, etc.), and the patient's visual status (e.g., Nellen visual acuity on each eye). As will be appreciated, other embodiments of the physical examination GUI 404 may include additional requests for information, without departing from the scope of the disclosure. After inputting the appropriate responses to the various queries, the fall assessment may proceed by clicking a “Next Tab” button (not shown).

Referring now to FIG. 4c, illustrated is a tests GUI 406 configured to provide another set of queries configured to determine aspects of various medical tests undertaken by the patient with respect to the fall event. For example, the tests GUI 406 may allow the user to input results of an electrocardiogram of the patient, an oxygen saturation of blood of the patient, and blood cell features and blood chemistry features of the patient. Once the various tests results have been populated or otherwise added to the tests GUI 406, the user may proceed by clicking a “Submit and Proceed” button 408.

After submitting the requested information for the fall assessment, the user may be presented with a fall explained GUI 410, as depicted in FIG. 4d, which may be configured to prompt the user to optionally determine whether the fall suffered by the patient was explained or unexplained. In some embodiments, FIG. 4d is a graphical representation of step 204 as described above with reference to FIG. 2a. In some embodiments, the fall summary GUI 410 may further include a brief summary 414 of the information submitted for the fall event for consideration, especially information that may be considered as abnormal. If the user is unable to positively identify or explain the reason for the fall, such a response is indicated in the fall explained GUI 410 and a “Submit” button 412 may then be clicked to proceed. Upon submitting the fall assessment information, the user may then be presented with a fall diagnosis GUI 416, as depicted in FIG. 4e. The fall diagnosis GUI 416 may be configured to display a diagnosis decision as calculated or otherwise processed by the fall assessment algorithm.

When the diagnosis of fall is uncertain, the algorithm may be configured to direct the user to the faint assessment algorithm with the assumption that the fall was a fainting episode with an unexplained cause, such as via an episode of amnesia suffered by the patient. According to various embodiments of the subject technology, when a patient has fallen and is uncertain about whether the patient has lost consciousness (e.g., the patient may have amnesia), then the same steps of the algorithm are performed as when the patient indicates that he or she has lost consciousness. For example, the algorithms may assume that the patient who fell has fainted as well. Thus, the same steps are performed as if the patient lost consciousness (e.g., the same queries are asked of the patient as if the patient lost consciousness).

Accordingly, the software that facilitates the fall assessment algorithm may be configured to process the submitted fall assessment information and determine the short-term risk and possible need for hospital admission in accordance with the faint assessment algorithm described herein. FIG. 4f illustrates an admission GUI 418 which may provide the user with a recommendation as to whether the patient should be admitted to a hospital for treatment or not. In some embodiments, FIG. 4f is a graphical representation of step 110 as described above with reference to FIG. 2a. If the short-term risk is high, as determined by the algorithm, the GUI 418 will recommend or suggest that the patient be admitted for treatment, and may provide a listing of the criteria used to reach said recommendation. At this point, the health care provider may be given the opportunity to agree or disagree with the recommendation provided by the algorithm and submit this determination by clicking on the “Submit” button 419.

If a decision is made not to admit the patient, the software may then be configured to use the available information to assess whether a certain diagnosis can be made. In some embodiments, the certain diagnosis GUI 354, as depicted in FIG. 3n, may be provided to the user and alert the user as to whether a certain diagnosis has or has not been ascertained with respect to a faint in conjunction with the purported fall event. In some embodiments, FIG. 3n is a graphical representation of step 114 as described above with reference to FIG. 2a. If the diagnosis is not certain, the user may then be presented with a main diagnosis GUI 420, as depicted in FIG. 4g, which may provide the user with one or more suggested fainting diagnoses 422 based on the information submitted surrounding the fall event. In some embodiments, FIG. 4g is a graphical representation of step 120 as described above with reference to FIG. 2a.

The suggested diagnosis may then be tested using one or more recommended tests, such as may be provided via the order tests GUI 362 of FIG. 3p, and the corresponding test results may be returned and evaluated, as depicted in test results GUI 364 of FIG. 3q. The user may repeat the process of ordering tests and inputting/evaluating the corresponding test results, as shown in FIGS. 3p and 3q, respectively, until a certain diagnosis is obtained. Once a certain diagnosis is obtained, the treatment GUI 366 shown in FIG. 3r may be provided to the user to provide the user with a treatment and follow-up plan corresponding to a faint main diagnosis obtained in conjunction with the fall event. In some embodiments, FIG. 3r is a graphical representation of step 118 as described above with reference to FIG. 2a. Upon submitting the treatment and follow-up plan corresponding to the fall event diagnosis, the software may be configured to provide the user with the clinic note GUI 370, as depicted in FIG. 3s. In some embodiments, FIG. 3s is a graphical representation of step 128 as described above with reference to FIG. 2a.

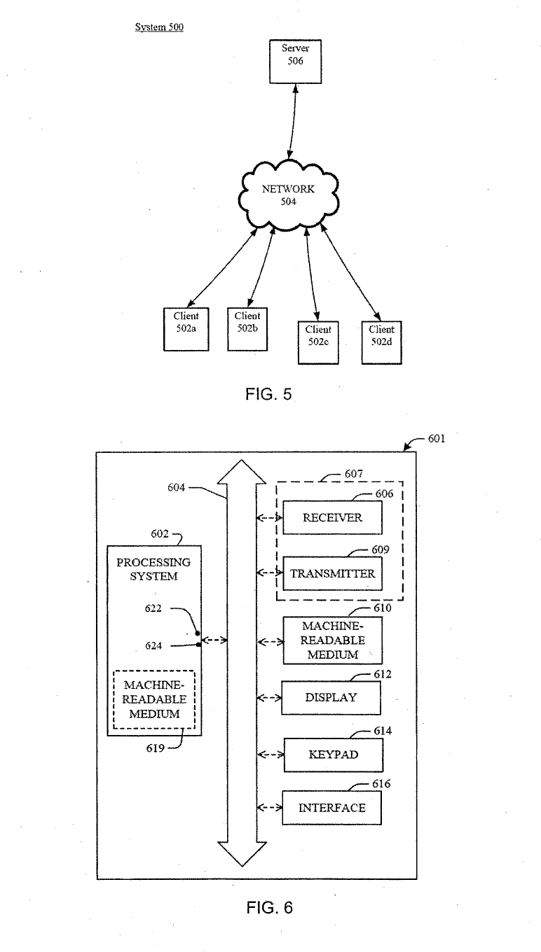

Referring now to FIG. 5, illustrated is a simplified diagram of a system 500, in accordance with various embodiments of the subject technology. In one or more embodiments, the system 500 may be configured to support or otherwise facilitate the use of one or more of the exemplary algorithms disclosed herein. The system 500 may include one or more remote client devices 502 (e.g., client devices 502a, 502b, 502c, and 502d) in communication with a server computing device 506 (server) via a network 504. In some embodiments, the server 506 is configured to run applications that may be accessed and controlled at the client devices 502. For example, a user at a client device 502 may use a web browser to access and control an application running on the server 506 over the network 504. In some embodiments, the server 506 is configured to allow remote sessions (e.g., remote desktop sessions) wherein users can access applications and files on the server 506 by logging onto the server 506 from a client device 502. Such a connection may be established using any of several well-known techniques such as the Remote Desktop Protocol (RDP) on a Windows-based server.

By way of illustration and not limitation, in one aspect of the disclosure, stated from a perspective of a server side (treating a server as a local device and treating a client device as a remote device), a server application is executed (or runs) at the server 506. While a remote client device 502 may receive and display a view of the server application on a display local to the remote client device 502, the remote client device 502 does not execute (or run) the server application at the remote client device 502. Stated in another way from a perspective of the client side (treating a server as remote device and treating a client device as a local device), a remote application is executed (or runs) at a remote server 506.

By way of illustration and not limitation, the client device 502 can represent a computer, a mobile phone, a laptop computer, a thin client device, a personal digital assistant (PDA), a portable computing device, or a suitable device with a processor. In one example, a client device 502 is a smartphone (e.g., IPHONE®, ANDROID®, BLACKBERRY®, etc.). In certain configurations, the client device 502 can represent an audio player, a game console, a camera, a camcorder, an audio device, a video device, a multimedia device, or a device capable of supporting a connection to a remote server. In one example, the client device 502 can be mobile. In another example, the client device 502 can be stationary. According to one aspect of the disclosure, the client device 502 may be a device having at least a processor and memory, where the total amount of memory of the client device 502 could be less than the total amount of memory in the server 506. In one example, the client device 502 does not have a hard disk. In one aspect, the client device 502 has a display smaller than a display supported by the server 506.

In some embodiments, the server 506 may represent a computer, a laptop computer, a computing device, a virtual machine (e.g., VMWARE® Virtual Machine), a desktop session (e.g., MICROSOFT® Terminal Server), a published application (e.g., MICROSOFT® Terminal Server) or a suitable device with a processor. In some embodiments, the server 506 can be stationary. In some embodiments, the server 506 can be mobile. In certain configurations, the server 506 may be any device that can represent a client device. In some embodiments, the server 506 may include one or more servers.

In one example, a first device is remote to a second device when the first device is not directly connected to the second device. In one example, a first remote device may be connected to a second device over a communication network such as a Local Area Network (LAN), a Wide Area Network (WAN), and/or other network.

When the client device 502 and the server 506 are remote with respect to each other, the client device 502 may connect to the server 506 over the network 504, for example, via a modem connection, a LAN connection including the Ethernet or a broadband WAN connection including DSL, Cable, T1, T3, Fiber Optics, Wi-Fi, or a mobile network connection including GSM, GPRS, 3G, WiMax or other network connection. The network 504 can be a LAN network, a WAN network, a wireless network, the Internet, an intranet or other network. The network 504 may include one or more routers for routing data between client devices and/or servers. A remote device (e.g., the client device 502, server 506, etc.) on a network may be addressed by a corresponding network address, such as, but not limited to, an Internet protocol (IP) address, an Internet name, a WINDOWS® Internet name service (WINS) name, a domain name or other system name. These illustrate some examples as to how one device may be remote to another device. But the subject technology is not limited to these examples.

FIG. 6 is a conceptual block diagram illustrating an example of a system 601, in accordance with various aspects of the subject technology. The system 601 may be configured to process, save, log, display, and/or transmit the information provided for the faint and fall assessment algorithms as generally described herein. The system 601 may be, for example, a client device (e.g., client device 502) or a server (e.g., server 506) a remote client device in communication with a server computing device via a network. In other embodiments, the system 601 may be the remote client device or the server computing device. The system 601 may include a processing system 602. The processing system 602 is capable of communication with a receiver 606 and a transmitter 609 through a bus 604 or other structures or devices. It should be understood that communication means other than busses can be utilized with the disclosed configurations. The processing system 602 can generate audio, video, multimedia, and/or other types of data to be provided to the transmitter 609 for communication. In addition, audio, video, multimedia, and/or other types of data can be received at the receiver 606, and processed by the processing system 602.

The processing system 602 may include a processor for executing instructions and may further include a machine-readable medium 619, such as a volatile or non-volatile memory, for storing data and/or instructions for software programs. The instructions, which may be stored in a machine-readable medium 610 and/or 619, may be executed by the processing system 602 to control and manage access to the various networks, as well as provide other communication and processing functions. The instructions may also include instructions executed by the processing system 602 for various user interface devices, such as a display 612 and a keypad 614. The processing system 602 may include an input port 622 and an output port 624. Each of the input port 622 and the output port 624 may include one or more ports. The input port 622 and the output port 624 may be the same port (e.g., a bi-directional port) or may be different ports.

The processing system 602 may be implemented using software, hardware, or a combination of both. By way of example, the processing system 602 may be implemented with one or more processors. A processor may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable device that can perform calculations or other manipulations of information.

A machine-readable medium can be one or more machine-readable media. Software shall be construed broadly to mean instructions, data, or any combination thereof, whether referred to as software, firmware, middleware, microcode, hardware description language, or otherwise. Instructions may include code (e.g., in source code format, binary code format, executable code format, or any other suitable format of code).

Machine-readable media (e.g., 619) may include storage integrated into a processing system, such as might be the case with an ASIC. Machine-readable media (e.g., 610) may also include storage external to a processing system, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device. Those skilled in the art will recognize how best to implement the described functionality for the processing system 602. According to one aspect of the disclosure, a machine-readable medium is a computer-readable medium encoded or stored with instructions and is a computing element, which defines structural and functional interrelationships between the instructions and the rest of the system, which permit the instructions' functionality to be realized. In one aspect, a machine-readable medium is a non-transitory machine-readable medium, a machine-readable storage medium, or a non-transitory machine-readable storage medium. In one aspect, a computer-readable medium is a non-transitory computer-readable medium, a computer-readable storage medium, or a non-transitory computer-readable storage medium. Instructions may be executable, for example, by a client device or server or by a processing system of a client device or server. Instructions can be, for example, a computer program including code.

An interface 616 may be any type of interface and may reside between any of the components shown in FIG. 6. An interface 616 may also be, for example, an interface to the outside world (e.g., an Internet network interface). A transceiver block 607 may represent one or more transceivers, and each transceiver may include a receiver 606 and a transmitter 609. A functionality implemented in a processing system 602 may be implemented in a portion of a receiver 606, a portion of a transmitter 609, a portion of a machine-readable medium 610, a portion of a display 612, a portion of a keypad 614, or a portion of an interface 616, and vice versa.

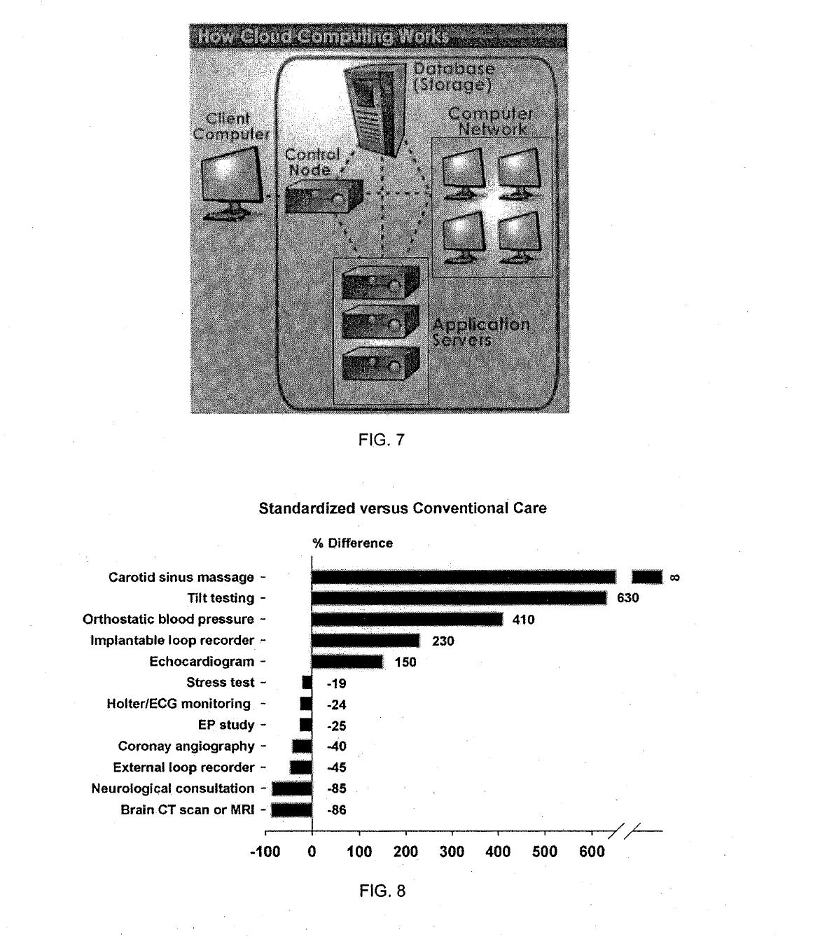

Referring now to FIG. 7, illustrated is an exemplary computing data model that may be used in conjunction with the disclosed exemplary algorithms provided for patients with faint or fall. Specifically, illustrated is a cloud computing data model. In some embodiments, the exemplary algorithms may be deployed in a secure data model through cloud-computing to leverage the power of the Internet. As described herein, the algorithms provide an educational tool that can advantageously be combined with cloud technology to benefit participants involved in the treatment of patients with faint and/or fall. In some embodiments, the algorithms may be presented on a website in which website access is highly secure, using password protection, restricted VPN access, and encryption technologies, while hosting the algorithms (e.g., in the form of an application) in a secure and protected internet data center.

As discussed above with reference to FIG. 3a, users may access the faint or fall assessment algorithms using various Internet browsers, such as CHROME®, SAFARI®, FIREFOX®, INTERNET EXPLORER®, etc. The database may run algorithmic reports in a designated internet data center, and the results may be presented to the users.

By taking advantage of the cloud computing architecture, the algorithm may be easily managed and upgraded. The creation and deletion of user accounts on the website may be managed on site or at various facilities. Cloud computing is an ideal technological solution for registries and decision-support algorithms. It may enable firms to leverage the power of remote resources with no information technology (IT) involvement. Cloud computing may shift the burden of managing and maintaining computing resources to the application provider, and provides users with the convenience of accessing information via an array of internet search engines.

Cloud computing may be an internet-based computing application, whereby shared resources, such as software and information, are provided to computers and other devices on-demand. It is a paradigm shift in the logical computing evolution from mainframe computers to client-server systems, and now to cloud computing. In cloud computing, details may be abstracted from the users who no longer need expertise in, or control over the technology infrastructure “in the cloud” that supports them. Cloud computing may describe a new consumption and delivery model for IT services based on the Internet, which involves the provision of dynamically scalable and virtualized resources as a service over the internet. Cloud computing has come as a byproduct and consequence of the ease-of-access to remote computing sites provided by the Internet.

The term “cloud” is used as a metaphor for the Internet, based on the cloud drawing used to depict the Internet in computer network diagrams as a representation of the underlying infrastructure the cloud represents. In some embodiments, cloud computing is provided for delivering a powerful business application online that users may access via their web browsers, while the actual software application (e.g., containing the algorithm), database and support software applets are stored on, and executed on servers located in a hardened, secure and protected internet data center. Cloud computing may enable users on different client machines such as Macs and personal computers (PCs) to access the same web-based application. It also may enable application providers to implement metrics on the server-side to scale resources to accommodate growing groups of users such that all users continue to have rapid response times.

According to certain embodiments, to provide additional layers of security, the application may only be accessible via various encryption methods (e.g., 128-bit encrypted Virtual Private Network (VPN) access). The algorithm's database may be a SQL-compatible relational database that is maintained on servers, which may be fully redundant with hot-swappable drives, fail-over potential, in a temperature-controlled, biometrically-secured data center. Comprehensive disaster-recovery programs may be maintained with daily and weekly backups, escrowed software, and redundant copies of critical software components.

According to various embodiments of the subject technology, a web-based application with a secure HIPAA-compliant portal is provided to allow clinicians to access the algorithms for patient assessment and reporting. Not only will the physician be able to assess the patient, but within a few minutes of documenting the patient history, exam findings and test results, the physician's report may be completed, which can then be exported to the electronic medical record, saving the physician a tremendous amount of time dictating the report, and shortening the time needed to generate patient bills.

The algorithms according to embodiments of the subject technology may be embodied in one or more modules. As used herein, the word “module” refers to logic embodied in hardware or firmware, or to a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware.

It is contemplated that the modules may be integrated into a fewer number of modules. One module may also be separated into multiple modules. The described modules may be implemented as hardware, software, firmware or any combination thereof. Additionally, the described modules may reside at different locations connected through a wired or wireless network, or the Internet.

In some embodiments, responses to computer-generated queries concerning a patient being assessed may be processed in any of a variety of ways. In some embodiments, responses to the sets of queries are processed by solving linear equations in which some or all of the responses are represented as variables weighted by appropriate coefficients. Where suitable, responses to the sets of queries can be processed by solving or estimating solutions to nonlinear equations, in which some or all of the responses are represented as variables weighted by appropriate coefficients and/or exponents. This processing produces outputs representing, e.g., determinations of recommendations of whether patients should be admitted to the hospital, recommendations for diagnoses and/or differential diagnoses of conditions that can lead to falls and/or fainting of patients, recommendations of further medical tests to be performed concerning patients, and so forth.

In general, it will be appreciated that the processors can include, by way of example, computers, program logic, or other substrate configurations representing data and instructions, which operate as described herein. In other embodiments, the processors can include controller circuitry, processor circuitry, processors, general purpose single-chip or multi-chip microprocessors, digital signal processors, embedded microprocessors, microcontrollers and the like.

Furthermore, it will be appreciated that in one embodiment, the program logic may advantageously be implemented as one or more components. The components may advantageously be configured to execute on one or more processors. The components include, but are not limited to, software or hardware components, modules such as software modules, object-oriented software components, class components and task components, processes methods, functions, attributes, procedures, subroutines, segments of program code, drivers, firmware, microcode, circuitry, data, databases, data structures, tables, arrays, and variables.

As will be appreciated, the embodiments disclosed herein will benefit every member of the healthcare spectrum (e.g., patients, doctors, hospitals, payers, etc.). Patients will benefit because the etiology of their faint or fall event will be diagnosed and treated more accurately in less time. Further, they will not be inappropriately admitted to the hospital as frequently done, saving them inconvenience, insurance payments for co-pays, and possible risks from exams Hospitals and insurers will benefit from the ability to provide improved care at lower cost. Finally, physicians will benefit from the ability to use this system, which will provide not only the educational tools but also the ability to automatically generate a clinic note and bill for the patient encounter. Moreover, embodiments disclosed herein may provide for the creation of an unprecedented database useful for any future medical queries.

The exemplary algorithms disclosed herein may be used by clinicians and insurance companies alike. Consequently, the algorithms may be designed for health payers and health care providers. In some embodiments, the algorithms may be designed specifically for faint uses, fall uses, or both faint and fall uses. When used by health payers, the disclosed embodiments provide a management tool that may assist insurance agents in their analysis of whether or not to authorize reimbursement for an admission to a hospital when a patient presents with a fainting or falling episode. Accordingly, incremental value is provided to health care payers via the disclosed embodiments, including, but not limited to, a reduction in the number of inappropriate admissions (which have been shown to account for ⅓ to ½ of the current faint admissions), and/or an increase in the yield to diagnosis in patients with faint or fall, thus reducing the recurrence rate and associated cost.

In some embodiments, an exemplary algorithm is disclosed that may be used by a clinician (e.g. physician, nurse practitioner, resident, fellow, etc.) who is attempting to diagnose and treat a patient presenting with a history of fainting or falling. The embodiments may provide an educational and informational tool that may assist the clinician by citing contextually relevant references from the medical literature describing the most likely diagnosis and underlying pathology.

With respect to hospitals, administrators strive to improve the quality of patient care and control healthcare costs. The algorithms disclosed herein, according to embodiments of the subject technology, may help administrators improve patient care, reduce liability, and increase profitability. Moreover, hospitals compete for market share in their communities and patients with faint or fall present both a challenge and an opportunity. For example, utilization of the disclosed algorithms may help hospitals improve their patient care and outcomes, as well as contribute to higher profitability.

Moreover, the embodiments disclosed herein may provide clinicians and hospitals with the engine for a specialized Faint and Fall Clinic (i.e., a designated syncope facility), a new line of service that may significantly increase its market share in the community. Recent data support the notion that a designated syncope facility, in either the emergency department or a hospital, can provide more efficient and effective triage and evaluation of patients than what would be accomplished by conventional approaches. In general, a considerable improvement in diagnostic yield and cost effectiveness (e.g., cost per reliable diagnosis) may be achieved in comparison to the usual practice. The benefit may be particularly high if a structured evaluation algorithm, such as the exemplary algorithms disclosed herein, were used.

### Example

A study undertaken at the University of Utah tested the hypothesis that utilization of a new standardized-care pathway, such as employing one or more of the exemplary algorithms disclosed herein, reduces hospital admissions, improves diagnostic yield, and decreases resource consumption when compared to the conventional approach. The study included reviewing the data of 154 consecutive patients presenting with faint to a designated syncope facility which employs one or more of the exemplary algorithms described herein to diagnose faint. The study also included reviewing the data of 100 patients previously evaluated for faint using a conventional approach to diagnosing faint. Data collected for both groups included information on admission rates, days of hospitalization, rate of diagnosis at initial evaluation and after 45 days of the work-up, and utilization of tests.

Table 1 outlines the characteristics of the patients in the standardized (n=154) and conventional (n=100) groups. Table 1 also includes information on baseline characteristics for a subgroup of patients who were evaluated in the outpatient setting (n=121, standardized group; n=57, conventional group), thus excluding those who were seen in the Emergency Department or same-day referrals to the FFC from the Emergency Department (n=33, standardized group; n=31, conventional group), and those directly hospitalized by the primary care physician (n=12, conventional group). Akin to the total population, the outpatient subgroups were well matched between the standardized and conventional groups.

TABLE 1
Patients' characteristics

| | Total population | | | Outpatients | | |
|---|---|---|---|---|---|---|
| | Standardized | Conventional | P | Standardized | Conventional | P |
| | 154 pts | 100 pts | value | 121 pts | 57 pts | value |
| Mean age (±SD) years | 55 ± 22 | 49 ± 21 | 0.03 | 56 ± 22 | 50 ± 22 | 0.09 |
| Female gender (%) | 93 (60%) | 57 (57%) | 0.60 | 74 (61%) | 34 (60%) | 0.87 |
| Present illness (%): | | | | | | |
| First episode | 41 (26%) | 33 (33%) | 0.26 | 31 (26%) | 18 (32%) | 0.47 |
| Recurrent syncopes | 115 (75%) | 67 (67%) | 0.26 | 90 (74%) | 39 (68%) | 0.47 |
| Major injuries (fractures, brain | 13 (8%) | 3 (3%) | 0.11 | 12 (10%) | 3 (5%) | 0.39 |
| concussion) (%) | | | | | | |
| Comorbidities (%): | | | | | | |
| History of structural heart disease | 21 (14%) | 22 (22%) | 0.09 | 16 (13%) | 13 (23%) | 0.13 |
| Previous myocardial infarction | 3 (2%) | 7 (7%) | 0.05 | 3 (2%) | 4 (7%) | 0.21 |
| Previous pacemaker or ICD | 3 (2%) | 5 (5%) | 0.3 | 3 (2%) | 3 (5%) | 0.39 |
| Hypertension | 53 (34%) | 27 (27%) | 0.27 | 44 (36%) | 18 (32%) | 0.61 |
| Hyperlipidemia | 46 (30%) | 19 (19%) | 0.08 | 36 (30%) | 14 (25%) | 0.59 |
| Any neurological disease | 22 (14%) | 5 (5%) | 0.02 | 16 (13%) | 2 (4%) | 0.06 |
| Diabetes | 21 (14%) | 11 (11%) | 0.70 | 16 (13%) | 7 (12%) | 1.00 |
| Pulmonary diseases | 9 (6%) | 1 (1%) | 0.09 | 6 (5%) | 0 (0%) | 0.18 |
| End-stage diseases (cancer, dialysis) | 0 (0%) | 2 (2%) | 0.15 | 0 (0%) | 1 (2%) | 0.32 |

Table 2 provides the resulting diagnosis and management of the standardized and conventional groups. Notably, using a standardized approach, as generally disclosed herein, only 4% of the total population and 2% of the outpatients were admitted following initial evaluation as compared to 20% and 16% in the conventional group, respectively (p<0.001 and p<0.001, respectively). Accordingly, hospitalizations were reduced by 81% (RRR=0.19 [95% CI=0.08-0.47]) in the total population and by 87% (RRR=0.13 [95% CI=0.04-0.44]) in the outpatient population when using the standardized approach, as generally described herein. The hospital length of stay was also less although the difference was not statistically significant. The rate of diagnosis at initial evaluation was similar between the groups; however, the rate of diagnosis at 45 days was greater in the standardized group when compared to the conventional group particularly in the outpatient setting (57% versus 45% for the total population, p=0.09; 57% versus 39% for the outpatient subgroups respectively, p=0.02).

TABLE 2
Diagnoses and management

| | Total population | | | Outpatients | | |
|---|---|---|---|---|---|---|
| | Standardized | Conventional | P | Standardized | Conventional | P |
| | n = 154 (%) | n = 100 (%) | value | n = 121 (%) | n = 57 (%) | value |
| Admission following initial | 6 (4%) | 20 (20%) | <0.001 | 3 (2%) | 9 (16%) | <0.001 |
| evaluation | | | | | | |
| Days of hospitalization (±SD) | 2.5 ± 1.0 | 3.0 ± 2.4 | 0.63 | 1.7 ± 0.6 | 3.5 ± 2.9 | 0.32 |
| after admission | | | | | | |
| Diagnosis at initial evaluation | 38 (25%) | 29 (29%) | 0.47 | 31 (26%) | 15 (26%) | 1.00 |
| Final diagnosis at the end of | 88 (57%) | 45 (45%) | 0.09 | 69 (57%) | 22 (39%) | 0.02 |
| work-up | | | | | | |
| Reflex | 46 (30%) | 17 (17%) | 0.04 | 33 (27%) | 10 (18%) | 0.19 |
| Orthostatic hypotension | 17 (11%) | 7 (7%)* | 0.38 | 13 (11%) | 6 (11%)* | 1.00 |
| Cardiac, arrhythmia | 8 (5%) | 11 (11%) | 0.09 | 8 (7%) | 4 (7%) | 1.00 |
| Cardiac, structural | 1 (1%) | 1 (1%) | 1.00 | 1 (1%) | 0 (0%) | 1.00 |
| Non-syncopal faint | 16 (10%) | 9 (9%) | 0.83 | 14 (12%) | 2 (4%) | 0.10 |
| Pseudo-syncope | 7 | 1 | | 6 | 1 | |
| Epilepsy | 2 | 2 | | 1 | 1 | |
| Others (falls, vertigo, sleep | 7 | 6 | | 7 | 0 | |
| disorders, etc) | | | | | | |
| Pending diagnosis after 45 days | 13 (8%) | 3 (3%) | 0.11 | 12 (10%) | 1 (2%) | 0.06 |
| (prolonged ECG monitoring) | | | | | | |
| Unknown diagnosis at the end of | 53 (34%) | 52 (52%) | 0.006 | 40 (33%) | 34 (60%) | 0.001 |
| work-up | | | | | | |

*In 3 patients, the diagnosis of orthostatic hypotension was assumed to be present based on the clinical history without any objective documentation

Referring to Table 4 and FIG. 8, illustrated are the types of tests and consultations completed in each group. As illustrated, the type of testing for each group differed significantly. In the standardized group, for example, there was an increase in syncope-specific baseline tests such as orthostatic blood pressure measurement, carotid sinus massage, ECG, echocardiogram and tilt table testing and a decrease in brain imaging and neurological consultation when compared to the conventional group. In addition, prolonged ECG monitoring was more often applied in the standardized group, especially among the outpatient subgroup. The increased diagnostic yield of the standardized group compared with the conventional group was largely due to the increased number of diagnoses made by orthostatic blood pressure measurement (19% versus 4% respectively, p=0.001) and tilt table testing (13% versus 1% respectively, p=0.001).

TABLE 4
Tests and Consultations

| | Standardized | Conventional | |
|---|---|---|---|
| | n = 154 (%) | n = 100 (%) | P value |
| Orthostatic BP measurement | 152 (99%) | 24 (24%) | 0.001 |
| Carotid sinus massage | 40 (26%) | 0 (0%) | 0.001 |
| Electrocardiogram | 152 (99%) | 85 (85%) | 0.001 |
| Echocardiogram | 141 (92%) | 62 (62%) | 0.001 |
| Tilt testing | 67 (44%) | 7 (7%) | 0.001 |
| Holter monitor | 25 (16%) | 21 (21%) | 0.40 |
| External loop recorder | 17 (11%) | 20 (20%) | 0.07 |
| Implantable loop recorder | 11 (7%) | 3 (3%) | 0.25 |
| Stress test | 15 (10%) | 11 (11%) | 0.83 |
| Electrophysiological study | 6 (4%) | 3 (3%) | 1.0 |
| Coronary angiography | 4 (3%) | 5 (5%) | 0.32 |
| Brain CT/MRI scan | 4 (3%) | 22 (22%) | 0.001 |
| Neurological consultation | 5 (3%) | 20 (20%) | 0.001 |

The total number of tests performed was slightly higher in the standardized group when compared to the conventional group (3.1±1.2 versus 2.8±1.3, p=0.06). However, the number of tests or consultations resulting in additional charges (i.e., all tests listed in Table 4, with the exception of orthostatic blood pressure measurement and carotid sinus massage) were significantly lower in the standardized group when compared to the conventional group (1.9±1.0 versus 2.6±1.2, p=0.001).

Accordingly, as illustrated in the results provided above, the use of a standardized approach in the evaluation of patients with faint decreased the number of hospital admissions, length of hospital stay, and increased the yield to diagnosis at 45 days. Significantly, this result was achieved with less utilization of costly tests and consultations and highlights the benefit in adopting standardized approaches in the evaluation of patients with faint.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

1. A computer-implemented method of assessing a patient, comprising:
displaying a first set of queries concerning a patient;
receiving an indicator response to at least one of the first set of queries, the indicator response indicating that the patient has recently experienced at least one of (i) losing consciousness, (ii) falling, and (iii) being uncertain about whether the patient has lost consciousness; and
when the indicator response indicates that the patient has lost consciousness:
(a) displaying a second set of queries concerning whether the loss of consciousness was triggered by at least one of emotional distress, fear, pain, instrumentation, and a blood phobia;
(b) receiving at least one response to the second set of queries;
(c) displaying a third set of queries concerning whether at least one of nausea, vomiting, abdominal pain, feeling cold, and sweating of the patient preceded the loss of consciousness;
(d) receiving at least one response to the third set of queries;
(e) displaying a fourth set of queries configured to determine each of (i) the patient's activity during the loss of consciousness; (ii) patient's position during the loss of consciousness; (iii) a completeness of the loss of consciousness; (iv) the patient's breathing pattern immediately prior to the loss of consciousness; (v) the patient's skin color immediately prior to the loss of consciousness; (vi) whether the patient exhibited, around the time of the loss of consciousness, at least one of muscle movements, automatisms, tongue biting, urinary or fecal incontinence, prolonged confusion, muscles aches, and trauma; and (vii) whether the patient has experienced prior episodes of loss of consciousness;
(f) receiving responses to the fourth set of queries;
(g) displaying a fifth set of queries configured to determine each of (i) the patient's history of alcohol intoxication; (ii) the patient's history of drug abuse; and (iii) the patient's history of tobacco use;
(h) receiving responses to the fifth set of queries;
(i) displaying a sixth set of queries configured to determine aspects of findings of the patient's physical examination;
j) receiving responses to the sixth set of queries;
(k) displaying a seventh set of queries configured to determine aspects of each of (i) an electrocardiogram of the patient; (ii) an oxygen saturation of blood of the patient; (iii) blood cell features and blood chemistry features of the patient; and (iv) an echocardiogram of the patient;
(l) receiving responses to the seventh set of queries; and
(m) based on the responses to the first through seventh sets of queries, determining, by a computer, (i) a recommendation of whether the patient should be admitted to a hospital; (ii) a recommendation of at least one of a diagnosis and a differential diagnosis of a condition that may have led to a loss of consciousness in the patient; and (iii) a recommendation of further medical tests to be performed concerning the patient.

2. The computer-implemented method of claim 1, further comprising: based on the responses to the first through seventh sets of queries, determining, by a computer, a recommended category for billing a third party for at least one of a diagnosis, a treatment, and a hospital stay of the patient.

3. The computer-implemented method of claim 1, further comprising: based on the responses to the first through seventh sets of queries, determining, by a computer, a recommended treatment for the patient's condition.

4. The computer-implemented method of claim 1, further comprising:
when the indicator response indicates that the patient has fallen:
(a) displaying an eighth set of queries concerning circumstances prior to the patient's fall;
(b) receiving at least one response to the eighth set of queries;
(c) displaying a ninth set of queries configured to determine each of (i) the patient's history of alcohol intoxication; (ii) the patient's history of drug abuse; and (iii) the patient's history of tobacco use;
(d) receiving responses to the ninth set of queries;
(e) displaying a tenth set of queries configured to determine aspects of findings of the patient's physical examination;
(f) receiving responses to the tenth set of queries;
(g) displaying an eleventh set of queries configured to determine aspects of each of (i) an electrocardiogram of the patient; (ii) an oxygen saturation of blood of the patient; (iii) blood cell features and blood chemistry features of the patient; and (iv) an echocardiogram of the patient; and
(h) receiving responses to the eleventh set of queries;
(i) based on the responses to the eighth through eleventh sets of queries, determining, by a computer, (i) a recommendation of whether the patient should be admitted to the hospital; (ii) a recommendation for at least one of a diagnosis and a differential diagnosis of a condition that can lead to a fall of the patient; and (iii) a recommendation of further medical tests to be performed concerning the patient.

5. The computer-implemented method of claim 4, further comprising: based on the responses to the eighth through eleventh sets of queries, determining, by a computer, a recommended category for billing a third party for at least one of a diagnosis, a treatment, and a hospital stay of the patient.

6. The computer-implemented method of claim 4, further comprising: based on the responses to the eighth through eleventh sets of queries, determining, by a computer, a recommended treatment for the condition.

7. The computer-implemented method of claim 4, when the indicator response indicates that the patient has fallen and is uncertain about whether the patient has lost consciousness, performing the same steps as when the indicator response indicates that the patient has lost consciousness.

8-11. (canceled)

12. A non-transitory machine-readable medium encoded with instructions executable by a processing system to perform a method for assessing a patient, the instructions comprising code for:
displaying a first set of queries concerning a patient;
receiving an indicator response to at least one of the first set of queries, the indicator response indicating that the patient has recently experienced at least one of (i) losing consciousness, (ii) falling, and (iii) being uncertain about whether the patient has lost consciousness; and
when the indicator response indicates that the patient has lost consciousness:
(a) displaying a second set of queries concerning whether the loss of consciousness was triggered by at least one of emotional distress, fear, pain, instrumentation, and a blood phobia;
(b) receiving at least one response to the second set of queries;
(c) displaying a third set of queries concerning whether at least one of nausea, vomiting, abdominal pain, feeling cold, and sweating of the patient preceded the loss of consciousness;
(d) receiving at least one response to the third set of queries;
(e) displaying a fourth set of queries configured to determine each of (i) the patient's activity during the loss of consciousness; (ii) patient's position during the loss of consciousness; (iii) a completeness of the loss of consciousness; (iv) the patient's breathing pattern immediately prior to the loss of consciousness; (v) the patient's skin color immediately prior to the loss of consciousness; (vi) whether the patient exhibited, around the time of the loss of consciousness, at least one of muscle movements, automatisms, tongue biting, urinary or fecal incontinence, prolonged confusion, muscles aches, and trauma; and (vii) whether the patient has experienced prior episodes of loss of consciousness;
(f) receiving responses to the fourth set of queries;
(g) displaying a fifth set of queries configured to determine each of (i) the patient's history of alcohol intoxication; (ii) the patient's history of drug abuse; and (iii) the patient's history of tobacco use;
(h) receiving responses to the fifth set of queries;
(i) displaying a sixth set of queries configured to determine aspects of findings of the patient's physical examination;
(j) receiving responses to the sixth set of queries;
(k) displaying a seventh set of queries configured to determine aspects of each of (i) an electrocardiogram of the patient; (ii) an oxygen saturation of blood of the patient; (iii) blood cell features and blood chemistry features of the patient; and (iv) an echocardiogram of the patient;
(l) receiving responses to the seventh set of queries; and
(m) based on the responses to the first through seventh sets of queries, determining, by a computer, (i) a recommendation of whether the patient should be admitted to a hospital; (ii) a recommendation of at least one of a diagnosis and a differential diagnosis of a condition that may have led to a loss of consciousness in the patient; and (iii) a recommendation of further medical tests to be performed concerning the patient.

13. The non-transitory machine-readable medium of claim 12, further comprising: based on the responses to the first through seventh sets of queries, determining, by a computer, a recommended category for billing a third party for at least one of a diagnosis, a treatment, and a hospital stay of the patient.

14. The non-transitory machine-readable medium of claim 12, further comprising: based on the responses to the first through seventh sets of queries, determining, by a computer, a recommended treatment for the patient's condition.

15. The non-transitory machine-readable medium of claim 12, further comprising:
when the indicator response indicates that the patient has fallen:
(a) displaying an eighth set of queries concerning circumstances prior to the patient's fall;
(b) receiving at least one response to the eighth set of queries;
(c) displaying a ninth set of queries configured to determine each of (i) the patient's history of alcohol intoxication; (ii) the patient's history of drug abuse; and (iii) the patient's history of tobacco use;
(d) receiving responses to the ninth set of queries;
(e) displaying a tenth set of queries configured to determine aspects of findings of the patient's physical examination;
(f) receiving responses to the tenth set of queries;
(g) displaying an eleventh set of queries configured to determine aspects of each of (i) an electrocardiogram of the patient; (ii) an oxygen saturation of blood of the patient; (iii) blood cell features and blood chemistry features of the patient; and (iv) an echocardiogram of the patient; and
(h) receiving responses to the eleventh set of queries;
(i) based on the responses to the eighth through eleventh sets of queries, determining, by a computer,
(i) a recommendation of whether the patient should be admitted to the hospital;
(ii) a recommendation for at least one of a diagnosis and a differential diagnosis of a condition that can lead to a fall of the patient; and
(iii) a recommendation of further medical tests to be performed concerning the patient.

16. The non-transitory machine-readable medium of claim 15, further comprising: based on the responses to the eighth through eleventh sets of queries, determining, by a computer, a recommended category for billing a third party for at least one of a diagnosis, a treatment, and a hospital stay of the patient.

17. The non-transitory machine-readable medium of claim 15, further comprising: based on the responses to the eighth through eleventh sets of queries, determining, by a computer, a recommended treatment for the condition.

18. The non-transitory machine-readable medium of claim 15, when the indicator response indicates that the patient has fallen and is uncertain about whether the patient has lost consciousness, performing the same steps as when the indicator response indicates that the patient has lost consciousness.

19-22. (canceled)

23. A computer-implemented system for assessing a patient, the system comprising:
a user input module for displaying a first set of queries concerning a patient, the first set or queries being configured to request an indicator response to at least one of the first set of queries, the indicator response indicating that the patient has recently experienced at least one of (i) losing consciousness, (ii) falling, and (iii) being uncertain about whether the patient has lost consciousness; and
wherein, when the indicator response indicates that the patient has lost consciousness, the user input module is configured to:
(a) display a second set of queries concerning whether the loss of consciousness was triggered by at least one of emotional distress, fear, pain, instrumentation, and a blood phobia;
(b) receive at least one response to the second set of queries;
(c) display a third set of queries concerning whether at least one of nausea, vomiting, abdominal pain, feeling cold, and sweating of the patient preceded the loss of consciousness;
(d) receive at least one response to the third set of queries;
(e) display a fourth set of queries configured to determine each of (i) the patient's activity during the loss of consciousness; (ii) patient's position during the loss of consciousness; (iii) a completeness of the loss of consciousness; (iv) the patient's breathing pattern immediately prior to the loss of consciousness; (v) the patient's skin color immediately prior to the loss of consciousness; (vi) whether the patient exhibited, around the time of the loss of consciousness, at least one of muscle movements, automatisms, tongue biting, urinary or fecal incontinence, prolonged confusion, muscles aches, and trauma; and (vii) whether the patient has experienced prior episodes of loss of consciousness;
(f) receive responses to the fourth set of queries;
(g) display a fifth set of queries configured to determine each of (i) the patient's history of alcohol intoxication; (ii) the patient's history of drug abuse; and (iii) the patient's history of tobacco use;
(h) receive responses to the fifth set of queries;
(i) display a sixth set of queries configured to determine aspects of findings of the patient's physical examination;
(j) receive responses to the sixth set of queries;
(k) display a seventh set of queries configured to determine aspects of each of (i) an electrocardiogram of the patient; (ii) an oxygen saturation of blood of the patient; (iii) blood cell features and blood chemistry features of the patient; and (iv) an echocardiogram of the patient;
(l) receive responses to the seventh set of queries; and
a processing module in communication with the user input module, the processing module being configured to, based on the responses to the first through seventh sets of queries, determine (i) a recommendation of whether the patient should be admitted to a hospital; (ii) a recommendation of at least one of a diagnosis and a differential diagnosis of a condition that may have led to a loss of consciousness in the patient; and (iii) a recommendation of further medical tests to be performed concerning the patient.

24. The system of claim 23, wherein the processing module is further configured to, based on the responses to the first through seventh sets of queries, determine a recommended category for billing a third party for at least one of a diagnosis, a treatment, and a hospital stay of the patient.

25. The system of claim 23, wherein the processing module is further configured to, based on the responses to the first through seventh sets of queries, determine a recommended treatment for the patient's condition.

26. The system of claim 23, wherein, when the indicator response indicates that the patient has fallen, the user input module is configured to:
(a) display an eighth set of queries concerning circumstances prior to the patient's fall;
(b) receive at least one response to the eighth set of queries;
(c) display a ninth set of queries configured to determine each of (i) the patient's history of alcohol intoxication; (ii) the patient's history of drug abuse; and (iii) the patient's history of tobacco use;
(d) receive responses to the ninth set of queries;
(e) display a tenth set of queries configured to determine aspects of findings of the patient's physical examination;
(f) receive responses to the tenth set of queries;
(g) display an eleventh set of queries configured to determine aspects of each of (i) an electrocardiogram of the patient; (ii) an oxygen saturation of blood of the patient; (iii) blood cell features and blood chemistry features of the patient; and (iv) an echocardiogram of the patient; and
(h) receive responses to the eleventh set of queries; and
wherein the processing module is configured to, based on the responses to the eighth through eleventh sets of queries, determine (i) a recommendation of whether the patient should be admitted to the hospital; (ii) a recommendation for at least one of a diagnosis and a differential diagnosis of a condition that can lead to a fall of the patient; and (iii) a recommendation of further medical tests to be performed concerning the patient.

27. The system of claim 26, wherein the processing module is further configured to, based on the responses to the eighth through eleventh sets of queries, determine a recommended category for billing a third party for at least one of a diagnosis, a treatment, and a hospital stay of the patient.

28. The system of claim 26, wherein the processing module is further configured to, based on the responses to the eighth through eleventh sets of queries, determine a recommended treatment for the condition.

29-33. (canceled)
